(19) United States
(12) Patent Application Publication
(10) Pub. No.: US 2026/0198500 A1
(43) Pub. Date: Jul. 16, 2026

(54) ANTIMICROBIAL MATERIALS, AND SYSTEMS AND METHODS FOR FABRICATION AND USE THEREOF

(71) Applicant: UNIVERSITY OF MARYLAND, COLLEGE PARK, College Park, MD (US)

(72) Inventors: Liangbing HU, Woodbridge, CT (US); Ji QIAN, Berwyn Heights, MD (US); William BENTLEY, Annapolis, MD (US); Kayla CHUN, College Park, MD (US); Yimin MAO, Germantown, MD (US); Robert BRIBER, Bethesda, MD (US)

(21) Appl. No.: 19/130,008

(22) PCT Filed: Nov. 15, 2023
(86) PCT No.: PCT/US23/79731

§ 371 Date: May 14, 2025

Related U.S. Application Data
(60) Provisional application No. 63/383,906, filed on Nov. 15, 2022.

(51) Int. Cl. A01N 59/20; A01N 25/10; A01N 25/34; A01N 59/16; A01P 1/00

(52) U.S. Cl. CPC A01N 59/20; A01N 25/10; A01N 25/34; A01N 59/16; A01P 1/00

(57) ABSTRACT

An antimicrobial material can include one or more fibers and a plurality of metal ions. Each fiber can have a plurality of cellulose molecular chains with functions groups. The metal ions can be impregnated within the one or more fibers such that each metal ion forms a coordination bond between functional groups of adjacent cellulose molecular chains. The one or more fibers can exhibit a cellulose-I lattice structure. In some examples, the antimicrobial material is provided as a surface layer in or on a substrate.

### CROSS-REFERENCE TO RELATED APPLICATIONS

The present application claims the benefit of U.S. Provisional Application No. 63/383,906, filed Nov. 15, 2022, entitled “Highly Stable, Antiviral, Antibacterial Paper, Textile, and Wood via Molecular Engineering,” which is hereby incorporated by reference herein in its entirety.

### FIELD

The present disclosure relates generally to antimicrobial materials, and more particularly, to fibers, such as cellulose-based fibers derived from plant materials, that have been modified with metal ions to act as antimicrobial materials.

### BACKGROUND

Textiles, such as clothing, bed linens, and towels, can harbor and transmit viruses and bacteria, particularly in healthcare settings. Exposed surfaces within a manufactured environment (e.g., parts of a structure, such as walls, tables or desks, doors, railings, etc.) can also harbor viruses or bacteria. Moreover, materials forming a manufactured environment can be susceptible to microbial growth (e.g., mold), which can degrade the materials, present a health hazard to animals in the vicinity (e.g., via release of harmful spores), give off an unpleasant odor, or otherwise present an unsightly appearance (e.g., a black stain).

Conventional antimicrobial agents, such as organic compounds (e.g., quaternary ammonium compounds, triclosan, polyhexamethylene biguanide, and N-halamines), may be effective against a wide range of microorganisms; however, these agents have also been linked to a number of environmental and health concerns. Moreover, many conventional antimicrobial agents are restricted to application on an exposed surface of the material (or microfibers thereof), which may be less durable in the face of environmental exposure and/or material usage (e.g., repeated washing and wearing). For example, antimicrobial additives are typically applied to textiles via vapor deposition, evaporation, sputtering, or spraying, which raises concerns about durability due to low additive adhesion, weak mechanical strength of the underlying material, and limited bonding ability (e.g., weak electrostatic interactions between the additives and the underlying material).

Embodiments of the disclosed subject matter may address one or more of the above-noted problems and disadvantages, among other things.

### SUMMARY

Embodiments of the disclosed subject matter provide antimicrobial materials, and systems and methods for fabrication and use thereof. In some embodiments, the antimicrobial material is derived from a fibrous plant material, for example, by impregnating metal ions within the cellulose molecular chains of the constituent fibers of the plant material. For example, the metal ions can form coordination bonds with exposed functional groups of the cellulose molecular chains. In some embodiments, the metal ions can include copper (Cu), zinc (Zn), gold (Au), silver (Ag), and/or titanium (Ti) ions. In some embodiments, the antimicrobial material is formed as a textile (e.g., clothing), a paper, or a structural material. Alternatively or additionally, in some embodiments, the antimicrobial material can be formed as part of a contiguous material (e.g., surface layer), or formed one or otherwise coupled to a separate material (e.g., substrate). Embodiments of the disclosed subject matter can be used in any application where antimicrobial properties may be beneficial, such as but not limited to personal or medical use clothing, personal protective equipment (e.g., face masks), household or medical furniture (e.g., tables, desks, cutting boards, etc.) or furnishings (e.g., curtains, drapes, rugs, upholstery, etc.), public transit (e.g., touch surfaces, such as railings, handles, seats, etc.), and structural materials (e.g., walls, framing, etc.).

In one or more embodiments, a structure can comprise an antimicrobial material. The antimicrobial material can comprise one or more fibers and a plurality of metal ions. Each fiber can comprise a plurality of cellulose molecular chains with functional groups. The plurality of metal ions can be impregnated within the one or more fibers, such that each metal ion forms a coordination bond between functional groups of adjacent cellulose molecular chains. The one or more fibers exhibit a cellulose-I lattice structure.

In one or more embodiments, a method can comprise exposing one or more microbes to an antimicrobial material of a structure so as to kill the one or more microbes and/or inhibit replication of the one or more microbes. The antimicrobial material can comprise one or more fibers and a plurality of metal ions. Each fiber can comprise a plurality of cellulose molecular chains with functional groups. The plurality of metal ions can be impregnated within the one or more fibers, such that each metal ion forms a coordination bond between functional groups of adjacent cellulose molecular chains. The one or more fibers can exhibit a cellulose-I lattice structure.

In one or more embodiments, a method can comprise immersing one or more fibers in an alkaline solution having the plurality of metal ions dissolved therein. Each fiber can comprise a plurality of cellulose molecular chains with functional groups. The immersing can be such that hydrogen bonds between the functional groups of adjacent cellulose molecular chains are broken so as to expose the functional groups and such that the dissolved metal ions become impregnated with the one or more fibers by forming coordination bonds with the exposed functional groups. The method can further comprise, after the immersing, rinsing the one or more fibers with the metal ions impregnated therein. The method can also comprise, after the rinsing, drying the one or more fibers so as to form an antimicrobial material. After the drying, the one or more fibers can exhibit a cellulose-I lattice structure.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1 is a simplified schematic diagram illustrating the hierarchical aligned structure of cellulose fibers in natural wood.

FIG. 2A is a simplified schematic diagram illustrating adjacent polymer molecular chains in an exemplary elementary nanofibril in an original unmodified state, according to one or more embodiments of the disclosed subject matter.

FIG. 2B is a simplified schematic diagram illustrating the nanofibril of FIG. 2A after immersion in an alkaline solution, thereby opening the space between the polymer molecular chains, according to one or more embodiments of the disclosed subject matter.

FIG. 2C is a simplified schematic diagram illustrating the nanofibril of FIG. 2B after bonding of dissolved metal ions from the alkaline solution to the functional groups of adjacent molecular chains, according to one or more embodiments of the disclosed subject matter.

FIG. 2D is a simplified schematic diagram illustrating the structure of FIG. 2C after drying, thereby forming an antimicrobial material, according to one or more embodiments of the disclosed subject matter.

FIG. 3A is a simplified schematic diagram illustrating an antimicrobial textile, according to one or more embodiments of the disclosed subject matter.

FIG. 3B is a simplified schematic diagram illustrating antimicrobial operation of integrated metal ions in a textile, according to one or more embodiments of the disclosed subject matter.

FIG. 3C illustrates radial, longitudinal, and rotary cut pieces of natural wood, as well as a cross-section in the radial-tangential plane of natural wood, which may be impregnated with metal ions to form an antimicrobial material, according to one or more embodiments of the disclosed subject matter.

FIG. 3D is a simplified schematic diagram illustrating formation of a densified, antimicrobial wood, according to one or more embodiments of the disclosed subject matter.

FIG. 3E is a simplified schematic diagram illustrating formation of an antimicrobial surface layer in a piece of fibrous plant material, according to one or more embodiments of the disclosed subject matter.

FIG. 3F is a simplified schematic diagram illustrating coating of an antimicrobial layer on a substrate, according to one or more embodiments of the disclosed subject matter.

FIG. 3G is a simplified schematic diagram illustrating provision of an antimicrobial layer on a substrate, according to one or more embodiments of the disclosed subject matter.

FIG. 4 is a simplified process flow diagram of a generalized method for forming and use of an antimicrobial material, according to one or more embodiments of the disclosed subject matter.

FIG. 5A is a simplified schematic diagram of an antimicrobial material fabrication system, according to one or more embodiments of the disclosed subject matter.

FIG. 5B is a simplified schematic diagram of an antimicrobial material fabrication system with recycle features, according to one or more embodiments of the disclosed subject matter.

FIG. 5C is a simplified schematic diagram of an antimicrobial material fabrication system with densification features, according to one or more embodiments of the disclosed subject matter.

FIG. 5D is a simplified schematic diagram of an antimicrobial material fabrication system with continuous manufacturing features, according to one or more embodiments of the disclosed subject matter.

FIG. 5E depicts a generalized example of a computing environment in which the disclosed technologies may be implemented.

FIG. 6A is a graph showing Cu ion content in fabricated Cu-ion textile (Cu-IT) samples as a function of soaking time, along with images of the fabricated samples.

FIG. 6B is a scanning electron microscopy (SEM) image and corresponding Cu elemental mapping of cotton microfibers in a fabricated Cu-IT sample.

FIG. 6C shows X-ray diffraction (XRD) profiles of unmodified textile and fabricated Cu-IT samples.

FIG. 6D shows X-ray photoelectron spectroscopy (XPS) results for Cu 2p spectrum of a fabricated Cu-IT sample.

FIG. 6E shows X-ray absorption near edge structure (XANES) spectra for Cu K-edge of a fabricated Cu-IT sample, as well as Cu, Cu₂O, and Cu(CH₃COO)₂ for comparison.

FIG. 6F shows extended X-ray absorption fine structure (EXAFS) spectrum of a fabricated Cu-IT sample, as well as a corresponding fitting curve.

FIG. 6G shows thermogravimetric analysis (TGA) traces for unmodified cotton textile and Cu-IT samples fabricated using different NaOH concentrations.

FIG. 6H shows remaining Cu weight percent of the different Cu-IT samples after the TGA measurements of FIG. 6G.

FIG. 6I shows energy-dispersive X-ray spectroscopy (EDS) spectra for a fabricated Cu-IT sample.

FIGS. 6J, 6K, and 6L show one-dimensional XRD traces for an unmodified cotton textile, a cotton textile treated with Cu(II)-saturated 10% NaOH before NaOH removal, and a fabricated Cu-IT sample, respectively.

FIG. 6M shows XPS wide scan spectra of unmodified textile and a fabricated Cu-IT sample.

FIG. 7A shows photographs of leaves with 500 ng/mL of tobacco mosaic virus (TMV) from an infectivity assay at 3 hours and 24 hours.

FIG. 7B is a graph of half leaf lesion counts of the two sides of the leaves inoculated with different TMV solutions.

FIG. 7C is a graph showing infectivity of low (3×10⁴ PFU/mL) and high (3×10⁶ PFU/mL) concentration of influenza A virus (IAV) after incubation without textile, with Cu-IT, and with unmodified textile.

FIG. 7D show photographs of Luria-Bertani broth (LB) agar plates after inoculation and overnight incubation of unmodified textile and Cu-IT treated bacteria cultures.

FIG. 7E is a graph of colony-forming units (CFU) counts measured from the antibacterial assay of FIG. 7D.

FIG. 8A shows a Cu K-edge XANES spectra of a Cu-IT sample before and after washing.

FIG. 8B shows EXAFS spectra of a Cu-IT sample before and after washing.

FIG. 8C shows XRD patterns of Cu-IT samples after different washing cycles.

FIG. 8D is a graph of average half leaf lesion counts of leave that have been inoculated with different TMV solutions.

FIG. 8E is a graph of CFU counts measured from the LB agar plates after inoculation and overnight incubation of the washed Cu-IT samples treated bacteria cultures.

FIG. 8F is a graph of measured tensile strength for unmodified cotton textile, textile treated by 10% NaOH, and a fabricated Cu-IT sample.

FIG. 9A shows wide-angle X-ray diffraction (WAXD) data for Cu-impregnated wood prepared using a Cu(II)-saturated aqueous NaOH solution at a concentration of 20 wt % NaOH.

FIG. 9B shows WAXD data for Cu-impregnated wood prepared using a Cu(II)-saturated aqueous NaOH solution at a concentration of 10 wt % NaOH.

FIG. 10 is a graph of measured tensile strengths for Cu-impregnated cellulose paper prepared using Cu(II)-saturated aqueous NaOH solutions at concentrations of 10 wt % NaOH and 20 wt % NaOH.

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about,” “substantially,” or “approximately” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following are provided to facilitate the description of various aspects of the disclosed subject matter and to guide those skilled in the art in the practice of the disclosed subject matter.

Fibrous Plant Material: A portion (e.g., a cut portion, via mechanical means or otherwise) of any photosynthetic eukaryote of the kingdom Plantae that is at least partially comprised of cellulose-based fibers. In some embodiments, the plant material comprises cotton (e.g., any of Gossypium hirsutum, Gossypium barbadense, Gossypium arboretum, Gossypium herbaceum, or hybrids thereof), wood (e.g., hardwood or softwood), bamboo (e.g., any of Bambusoideae, such as but not limited to Moso, Phyllostachys vivax, Phyllostachys viridis, Phyllostachys bambusoides, and Phyllostachys nigra), reed (e.g., any of common reed (Phragmites australis), giant reed (Arundo donax), Burma reed (Neyraudia reynaudiana), reed canary-grass (Phalaris arundinacea), reed sweet-grass (Glyceria maxima), small-reed (Calamagrostis species), paper reed (Cyperus papyrus), bur-reed (Sparganium species), reed-mace (Typha species), cape thatching reed (Elegia tectorum), and thatching reed (Thamnochortus insignis)), or grass (e.g., a species selected from the Poales order or the Poaceae family). For example, the wood can be any type of hardwood (e.g., having a native lignin content in a range of 18-25 wt %) or softwood (e.g., having a native lignin content in a range of 25-35 wt %), such as, but not limited to, basswood, oak, poplar, ash, alder, aspen, balsa wood, beech, birch, cherry, butternut, chestnut, cocobolo, elm, hickory, maple, oak, padauk, plum, walnut, willow, yellow poplar, bald cypress, cedar, cypress, douglas fir, fir hemlock, larch, pine, redwood, spruce, tamarack, juniper, and yew. Alternatively, in some embodiments, the plant material can be any type of fibrous plant composed of cellulose (with or without hemicellulose and/or lignin). For example, the plant material can be bagasse (e.g., formed from processed remains of sugarcane or sorghum stalks) or straw (e.g., formed from processed remains of cereal plants, such as rice, wheat, millet, or maize).

Cellulose-I Lattice Structure: The crystalline structure found in naturally-occurring (e.g., produced in fibrous plant materials) cellulose, which exists in parallel strands or microfibrils, for example, as described in Perez et al., “Structure and Engineering of Celluloses,” Advances in Carbohydrate Chemistry and Biochemistry, 2010, 64: pp. 25-116, which description is incorporated by reference herein.

Cellulose-I Lattice Structure: A modified version of cellulose, which exists in an antiparallel arrangement of cellulose microfibrils, for example, as described in Perez et al., incorporated by reference above. In some embodiments, the formation of cellulose-II can be achieved by subjecting cellulose-I to mercerization (e.g., by treatment with NaOH).

Antimicrobial material: A material that kills bacteria, viruses, fungi, and/or protozoa, and/or prevents (or at least inhibits) growth and/or reproduction of bacteria, viruses, fungi, and/or protozoa.

Elementary fibril (also referred to as elementary nanofibril): A basic nanoscale, elongated structure comprised of a plurality of polymer molecular chains (e.g., 10-36 chains) stacked in parallel or antiparallel directions. For example, elementary fibrils can have an original (e.g., unmodified) diameter of 5 nm or less (e.g., about 1.5-3.5 nm), depending on the plant material.

Nanofiber: A nanoscale, elongated structure comprised of a plurality of elementary fibrils. For example, nanofibers can have an original (e.g., unmodified) diameter of about 10 nm, depending on the plant material.

Microfibril: A microscale, elongated structure comprised of a plurality of elementary fibrils arranged in parallel. For example, microfibrils can have an original (e.g., unmodified) diameter of about 1-10 μm, depending on the plant material.

Fiber: An elongated structure comprised of a plurality of microfibrils arranged in parallel or a plurality of nanofibers arranged in parallel. For example, fibers can have an original (e.g., unmodified) diameter of about 30 μm-1 mm, depending on the plant material.

Functional group: A group of atoms or molecules of the cellulose molecular chain that can be exposed or modified by exposure to an alkaline solution. In some embodiments, the functional groups exposed are OH molecules and/or O atoms.

Coordinate bond: A covalent dipolar bond between a metal donor ion and surrounding ligands (e.g., the functional groups of cellulose molecular channels), with the metal ion acting as a coordination center.

Free liquid (e.g., free water): Liquid within a structure that is not in chemical combination with the structure, such that the liquid is capable of moving within or through the structure.

Bound liquid (e.g., bound water): Liquid within a structure that is in chemical combination with the structure, such that liquid cannot move within or through the structure.

Moisture content: The amount of fluid (e.g., water) retained within a structure. In some embodiments, the moisture content (MC) can be determined by oven-dry testing, for example by calculating the change in weight achieved by oven drying (e.g., at 103° C. for 6 hours) the structure, using the equation:

$$MC ( \% ) = \frac{weight before dry - weight after dry}{weight before dry} \times 100.$$

Alternatively weight before dry or additionally, moisture content can be assessed using known techniques in the art, for example, an electrical moisture meter or other techniques disclosed in ASTM D4442-20 (2020) for “Standard Test Methods for Direct Moisture Content Measurement of Wood and Wood-based Materials,” published by ASTM International, which standard is incorporated herein by reference.

Contiguous piece: A single continuous piece of fibrous plant material (e.g., a continuous piece of wood taken from a single tree) and subject to processing, as contrasted with a single piece formed by joining or layering multiple subpieces (e.g., laminate). In some embodiments, the contiguous piece consists essentially of the fibrous plant material (e.g., formed from the single continuous piece of plant material, but optionally including a surface coating or additives, for example, to form or otherwise provide the antimicrobial material).

Lignin-compromised plant material: Plant material that has been modified by one or more chemical treatments to (a) in situ modify the native lignin therein, (b) partially remove the native lignin therein (i.e., partial delignification), or (c) fully remove the native lignin therein (i.e., full delignification). In some embodiments, the lignin-compromised plant material can substantially retain the native microstructure of the natural plant material formed by cellulose-based cell walls.

Partial Delignification: The removal of some (e.g., at least 1%) but not all (e.g., less than or equal 90%) of native lignin (e.g., on a weight percent basis) from the naturally-occurring plant material. In some embodiments, the partial delignification can be performed by subjecting natural plant material to one or more chemical treatments (e.g., immersion in an alkaline solution). In some embodiments, a chemical treatment to provide metal ions within fibers of the plant material can also at least partially delignify the plant material. In some embodiments, the lignin content after partial delignification can be in a range of 0.9-23.8 wt % for hardwood (or bamboo) or in a range of 1.25-33.25 wt % for softwood. Lignin content within the plant material before and after the partial delignification can be assessed using known techniques in the art, for example, Laboratory Analytical Procedure (LAP) TP-510-42618 for “Determination of Structural Carbohydrates and Lignin in Biomass,” Version 08-03-2012, published by National Renewable Energy Laboratory (NREL), and ASTM E1758-01(2020) for “Standard Test Method for Determination of Carbohydrates in Biomass by High Performance Liquid Chromatography,” published by ASTM International, both of which are incorporated herein by reference. In some embodiments, the partial delignification process can be, for example, as described in U.S. Publication No. 2020/0223091, published Jul. 16, 2020 and entitled “Strong and Tough Structural Wood Materials, and Methods for Fabricating and Use Thereof,” and U.S. Publication No. 2022/0412002, published Dec. 29, 2022 and entitled “Bamboo Structures, and Methods for Fabrication and Use Thereof,” which delignification and densification processes are incorporated herein by reference.

Full Delignification: The removal of substantially all (e.g., 90-100%) of native lignin from the naturally-occurring plant material. In some embodiments, the full delignification can be performed by subjecting the natural plant material to one or more chemical treatments. Lignin content within the plant material before and after the full delignification can be assessed using the same or similar techniques as those noted above for partial delignification. In some embodiments, the full delignification process can be, for example, as described in U.S. Publication No. 20200238565, published Jul. 30, 2020 and entitled “Delignified Wood Materials, and Methods for Fabricating and Use Thereof,” which delignification processes are incorporated herein by reference.

Lignin modification: In situ altering one or more properties of native lignin in the naturally-occurring plant material, without removing the altered lignin from the plant material. In some embodiments, the lignin content of the plant material prior to and after the in situ modification can be substantially the same, for example, such that the in situ modified plant material retains at least 95% (e.g., removing no more than 1%, or no more than 0.5%, of the native lignin content) of the native lignin content. In some embodiments, the plant material can be in situ modified (e.g., by chemical reaction with OH⁻) to depolymerize lignin, with the depolymerized lignin being retained within the plant material microstructure. The lignin content within the plant material before and after lignin modification can be assessed using known techniques in the art, for example, Laboratory Analytical Procedure (LAP) TP-510-42618 for “Determination of Structural Carbohydrates and Lignin in Biomass,” Version 08-03-2012, published by National Renewable Energy Laboratory (NREL), ASTM E1758-01(2020) for “Standard Test Method for Determination of Carbohydrates in Biomass by High Performance Liquid Chromatography,” published by ASTM International, and/or Technical Association of Pulp and Paper Industry (TAPPI), Standard T 222-om-83, “Standard Test Method for Acid-Insoluble Lignin in Wood,” all of which are incorporated herein by reference. In some embodiments, the lignin modification process can be, for example, as described in International Publication No. WO 2023/028356, published Mar. 2, 2023, and entitled “Waste-free Processing for Lignin Modification of Fibrous Plant Materials, and Lignin-modified Fibrous Plant Materials,” which lignin modification processes are incorporated herein by reference.

Densified Plant Material: A fibrous plant material (e.g., wood or bamboo) that has been compressed to have a reduced thickness. In some embodiments, the thickness has been reduced by a factor of at least three. In some embodiments, the densified plant material can have a density greater than that of the native plant material, for example, at least 1.15 g/cm³, such as at least 1.2 g/cm³ or even at least 1.3 g/cm³ (e.g., 1.4-1.5 g/cm³). For example, the densified plant material can be formed as described in, but not limited to, U.S. Pat. No. 11,130,256, issued Sep. 28, 2021, entitled “Strong and Tough Structural Wood Materials, and Methods for Fabricating and Use Thereof,” and International Publication No. WO 2021/108576, published Jun. 3, 2021, entitled “Bamboo Structures, and Methods for Fabrication and Use Thereof,” each of which is incorporated herein by reference.

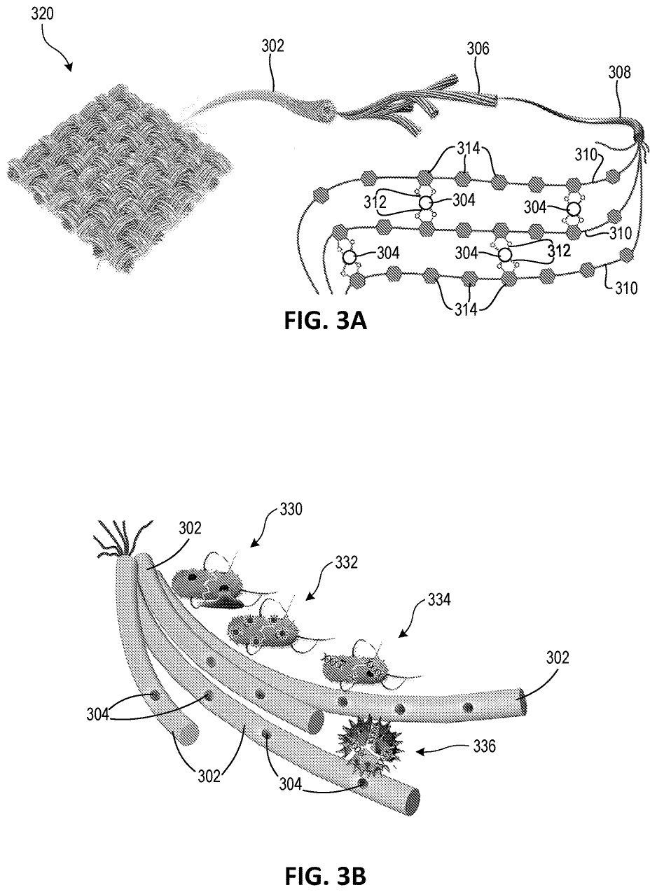

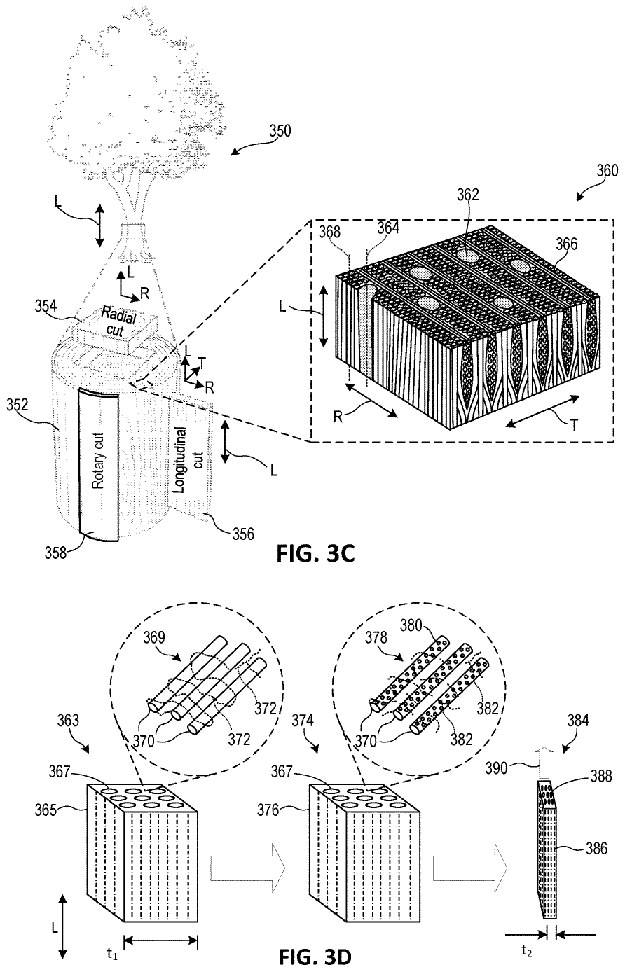

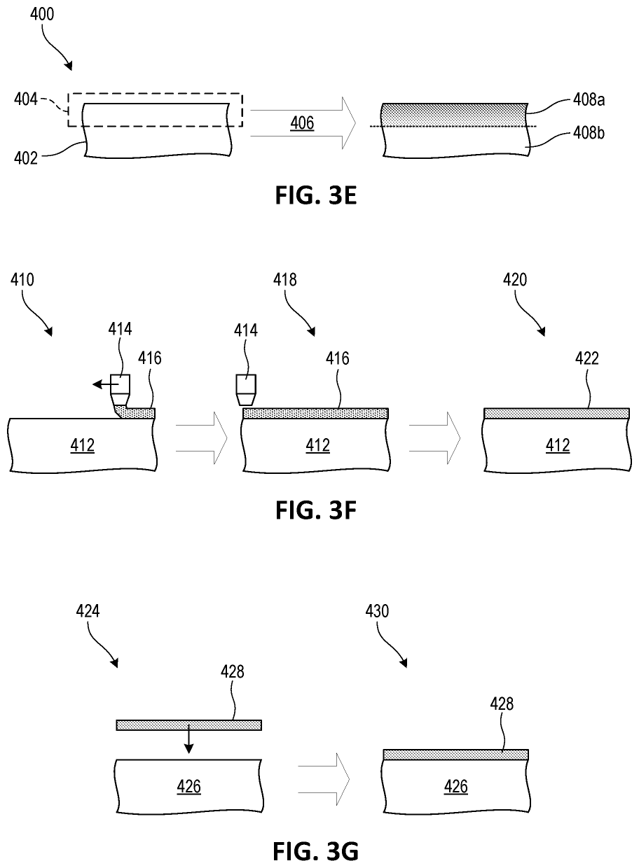

Longitudinal growth direction (L): A direction along which a plant grows from its roots or from a main body thereof (e.g., direction L for trunk 352 from tree 350 in FIG. 3C). Cellulose nanofibers forming cell walls of fiber cells, vessels, and/or tracheids of the fibrous plant material may generally be aligned with the longitudinal direction. In some cases, the longitudinal direction for the fibrous plant material may be generally vertical and/or correspond to a direction of the plant's water transpiration stream (e.g., from roots of the tree). The longitudinal direction can be perpendicular to the radial and tangential directions of the fibrous plant material.

Radial growth direction (R): A direction that extends from a center portion of the fibrous plant material outward (e.g., direction R for trunk 352 from tree 350 in FIG. 3C). In some cases, the radial direction for the native fibrous plant material may be generally horizontal. The radial direction can be perpendicular to the longitudinal and tangential directions of the fibrous plant material.

Tangential growth direction (T) or circumferential direction: A direction perpendicular to both the longitudinal and radial directions in a particular cut of fibrous plant material (e.g., direction T for trunk 352 from tree 350 in FIG. 3C). In some cases, the tangential direction for the native fibrous plant material may be generally horizontal. In some embodiments, the tangential direction can follow a growth ring of the fibrous plant material.

### INTRODUCTION

Disclosed herein are antimicrobial materials that have metal ions impregnated within polymer fibers, for example, bonded between functional groups of polymer molecular chains. In some embodiments, the polymer fibers are cellulose fibers within or derived from a naturally-occurring fibrous plant material (e.g., wood, bamboo, grass, cotton, ramie fiber, etc.). Alternatively or additionally, in some embodiments, the polymer fibers are cellulose fibers within or derived from a bacteria source or any other fibrous cellulose source (e.g., non-plant material). In some embodiments, the metal ions can include copper (Cu), zinc (Zn), gold (Au), silver (Ag), and/or titanium (Ti) ions. For example, cupric ions (e.g., copper(II) or Cu²⁺) can strongly coordinate with oxygen-containing polar functional groups (e.g., hydroxyl) of cellulose chains in the fibrous plant material. In addition to providing antimicrobial effects, the strong coordination bonding between the impregnated metal ions and the polar functional groups can improve the mechanical strength and/or environmental stability (e.g., abrasion resistance) of the fibrous plant material.

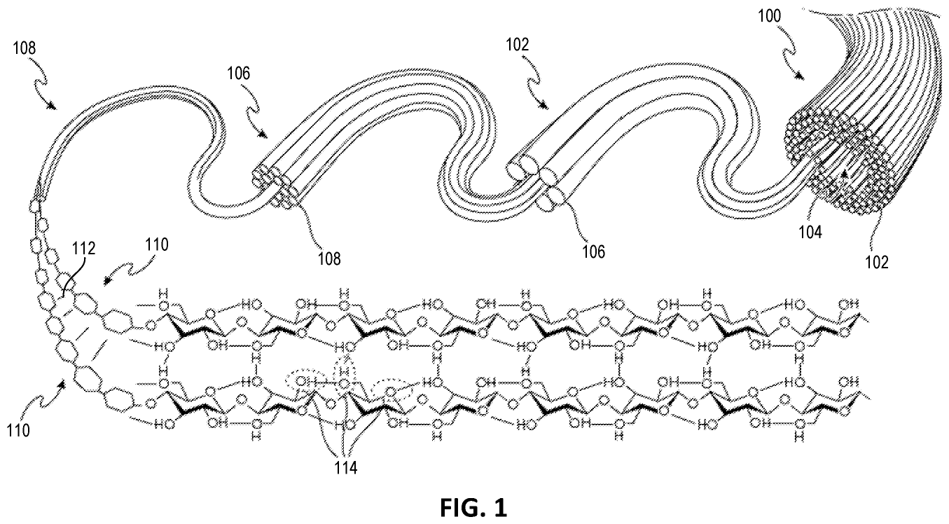

Natural wood has a unique three-dimensional porous structure with multiple channels, including vessels and tracheid lumina (e.g., tubular channels of 20-80 μm in cross-sectional dimension) extending in a direction of wood growth. Walls of cells in the natural wood are primarily composed of cellulose (40 wt %-50 wt %), hemicellulose (20 wt %-30 wt %), and lignin (20 wt %-35 wt %), with the three components intertwining with each other to form a strong and rigid wall structure. Cellulose fibers in the secondary cell wall (S2 layer) of the natural wood are substantially aligned along the wood growth direction. The naturally-occurring cellulose exhibits a hierarchical structure, which can be exploited in embodiments to provide the disclosed antimicrobial properties. For example, as shown in FIG. 1, a natural wood cell 100 has a plurality of cellulose fibers 102 surrounding and extending substantially parallel to lumen 104. The cellulose fibers 102 can be separated into constituent high-aspect-ratio microfibrils 106 in the form of aggregated three-dimensional networks (e.g., as bundles) that provide relatively high surface area. The cellulose microfibrils 106 can be further subdivided into elementary fibrils 108, which are composed of 12-36 linear polymer molecular chains 110. Each polymer molecular chain 110 is formed of thousands of repeating glucose units connected by strong covalent bonds that are arranged in a highly-ordered crystalline structure (e.g., cellulose-I lattice structure). The polymer molecular chains 110 are held together in a densely-packed arrangement forming the elementary fibril 108 by intramolecular hydrogen bonding 112 between functional groups 114 of adjacent molecular chains 110.

In some embodiments, some or all of the cellulose fibers 102 forming the wood can be modified to include metal ions between constituent polymer molecular chains 110 so as to alter or improve antimicrobial properties thereof. Hydrogen bonds between functional groups of the cellulose molecular chains can be broken by immersing the fibers 102 (e.g., retained as contiguous structure, such as a wood block, or released from the wood, such as via chemical or mechanical fibrillation) in an alkaline solution, thereby increasing spacing between adjacent cellulose molecular chains 110 and exposing the functional groups 114. Metal ions dissolved in the alkaline solution can diffuse into the enlarged space between the adjacent cellulose molecular chains and can form coordination bonds between the exposed functional groups 114. After rinsing and drying, the metal ions can be remained bonded to and between the adjacent cellulose molecular chains, thereby forming an antimicrobial material.

In some embodiments, the processing of the fibrous plant material to yield an antimicrobial material can employ a “top-down” approach, for example, to take advantage of an existing microstructure arrangement of the source material. For example, a contiguous piece of fibrous plant material can be subjected to one or more of the chemical modifications described herein. The contiguous can be cut in any direction with respect to its growth direction. Since the cellulose fibers are naturally aligned with the growth direction, the direction of the cut may dictate the orientation of the elementary fibrils in the final structure, which orientation can affect mechanical properties of the final structure. For example, in some embodiments, the contiguous piece can be vertical cut (e.g., parallel to tree growth direction) such that resulting cellulose fibers are oriented substantially parallel to a major face (e.g., largest surface area) of the cut piece. In some embodiments, the contiguous piece can be horizontal or rotation cut (e.g., perpendicular to tree growth direction), such that resulting fibers are oriented substantially perpendicular to the major face of the cut structure. In some embodiments, the contiguous piece can be cut at any orientation between the horizontal and vertical cuts.

In some embodiments, the piece of fibrous plant material (e.g., wood or bamboo) can be partially delignified or fully delignified prior to impregnation of the metal ions. Alternatively or additionally, in some embodiments, the piece of fibrous plant material may experience at least some lignin removal during impregnation of the metal ions, for example, due to exposure to the alkaline solution in which the metal ions are dissolved. In some embodiments, some, most, or substantially all of the hemicellulose may also be removed at a same time as the lignin removal. In some embodiments, substantially all of the lignin and hemicellulose can be removed prior to metal ion impregnation, thereby providing a cellulose-only structure.

In some embodiments, the piece of fibrous plant material (whether natural or delignified) can be subject to densification prior to or after the desired chemical modification of the elementary cellulose nanofibrils. As used herein, “densification” refers to the process of pressing the fibrous plant material in a direction crossing a longitudinal axis of the cellulose fibers (e.g., a direction of extension of the lumina, or a growth direction, of the fibrous plant material), for example, such that the lumina mostly or fully collapse (e.g., such that the thickness of the fibrous plant material is reduced by at least 75%, for example, ~90%). Exemplary processes for performing such densification are described in, for example, U.S. Pat. No. 11,130,256 and International Publication No. WO 2021/108576, which were incorporated by reference above.

In some embodiments, the “top-down” approach can employ an initial source material having a patterned arrangement of fibers. For example, the initial source material can be woven fabric or textile (e.g., formed of cotton fibers). Impregnating the source material with metal ions can thus result in an antimicrobial structure that inherits the patterned arrangement. Alternatively or additionally, the “top-down” approach can employ an initial source material having a random arrangement of fibers. For example, the initial source material can be a piece of paper with random orientation of cellulose fibers. Impregnating the paper can thus result in an antimicrobial structure that inherits the random arrangement.

In some embodiments, the processing of the fibers from an initial source material can employ a “bottom-up” approach, for example, to provide a structure independent of the microstructure of the source material. For example, a piece of natural wood (or other starting cellulose material) can be fibrillated prior to or after the metal ion impregnation. In some embodiments, such fibrillation can release cellulose fibers from the aggregate hierarchical structure (e.g., the parent wood block). Alternatively or additionally, in some embodiments, such fibrillation can release the cellulose microfibrils and/or the elementary fibrils from the hierarchical structure. Fibrillation can be performed by any method known in the art, such as but not limited to chemical means (e.g., chemical fibrillation, such as a (2,2,6,6-Tetramethylpiperidin-1-yl)oxyl (TEMPO) treatment), mechanical means (e.g., mechanical fibrillation, such as disk grinding), and/or enzymatic means (e.g., an enzymatic fibrillation process employing canonical cellulase enzymes, such as endoglucanases, in combination with amorphogenesis-inducing proteins, such as lytic polysaccharide monooxygenases (LPMO), swollenin, and hemicelluloses).

In some embodiments, after fibrillation, the separated fibers, microfibrils, and/or elementary fibrils can be assembled into a new structure, arrangement, or configuration. For example, a slurry containing the separated fibers, microfibrils, and/or elementary fibrils (e.g., prior to or after metal ion impregnation) can be vacuum-filtered and pressed to form a paper with random orientation of fibers, microfibrils, and/or elementary fibrils. Alternatively or additionally, in some embodiments, the fibers, microfibrils, and/or elementary fibrils (e.g., prior to or after metal ion impregnation) can be added to or incorporated with another material to form a composite structure. For example, a slurry containing the separated fibers, microfibrils, and/or elementary fibrils (e.g., after metal ion impregnation) can be coated on a substrate and subsequently dried to form an antimicrobial layer on the substrate.

### Metal Ion Impregnation

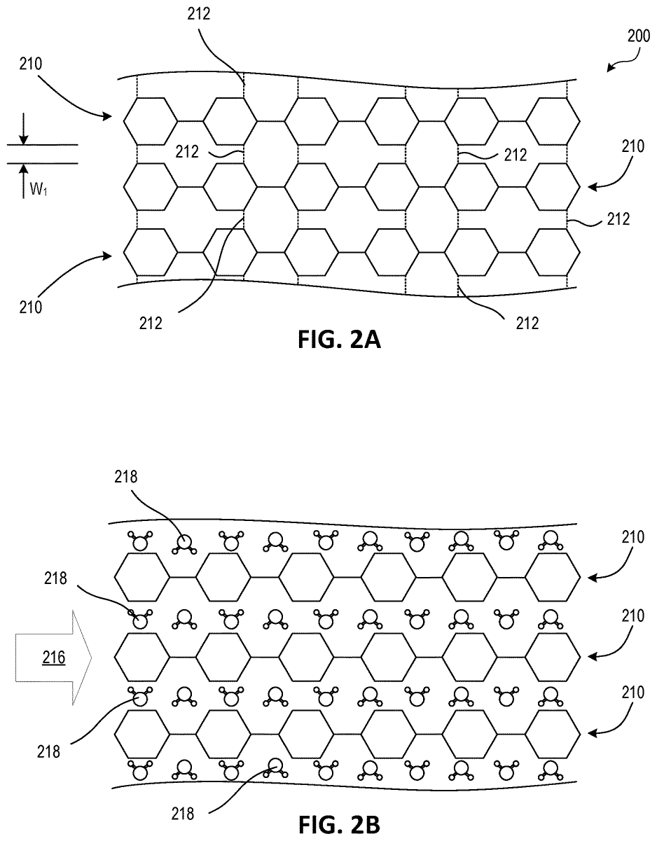

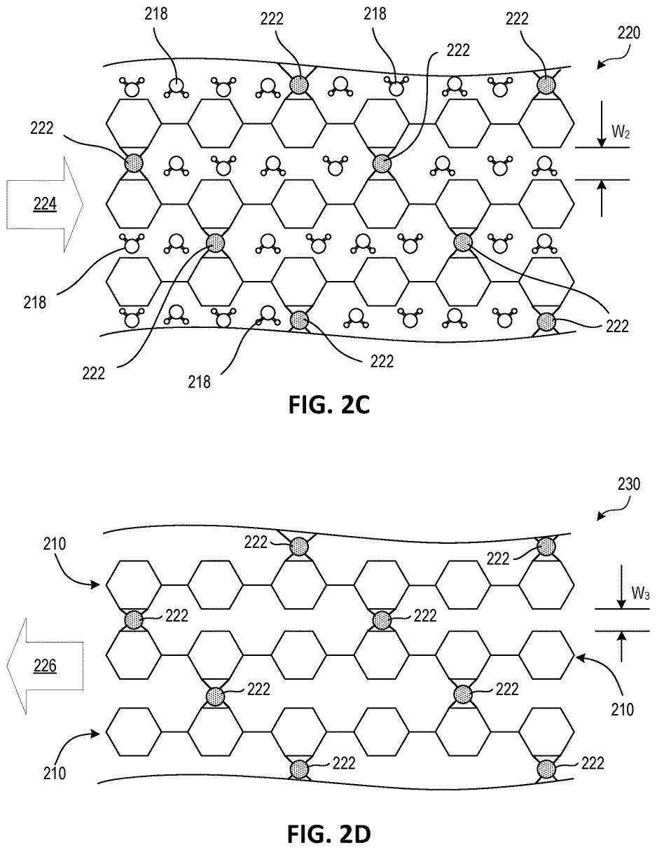

FIGS. 2A-2D illustrate exemplary aspects of metal impregnation between polymer molecular chains in a fiber to form an antimicrobial material. In an initial (e.g., unmodified or native) state 200, adjacent polymer molecular chains 210 of a fiber are held together in a densely-packed arrangement by hydrogen bonding 212 between functional groups. In some embodiments, the polymer molecular chains 210 are cellulose molecular chains, for example, within fibers of or derived from a fibrous plant material (e.g., cotton, wood, bamboo, etc.). The cellulose molecular chains can be in a native state, for example, exhibiting a cellulose-I lattice structure. The hydrogen bonds 212 can maintain a spacing, W₁, between the adjacent chains 210 of ≤1 nm (e.g., ≤about 0.6 nm for cellulose molecular chains).

By immersing 216 the fiber(s) in an alkaline solution (e.g., NaOH, KOH, LiOH), the hydrogen bonds 212 between functional groups can be broken, thereby allowing the space between adjacent polymer molecular chains 210 to increase, as shown in FIG. 2B. For example, the terminal OH⁻ groups of cellulose molecular chains within the fiber can be exposed when immersed in the alkaline solution, due to the low dissociation energy of the hydroxyl groups in the alkaline environment. With the increased spacing between molecular chains 210, the fiber(s) can be subjected to a metal ion treatment 224, where metal ions 222 dissolved in solution can diffuse between the polymer molecular chains 210 and bond thereto. In particular, the dissolved metal ions 222 can form a coordination bond with the exposed functional groups of adjacent polymer molecular chains 210, as shown in FIG. 2C.

In some embodiments, the dissolved metal ions 222 can be provided in the alkaline solution used to open up the polymer molecular chains 210 in FIG. 2B, such that the alkaline solution immersion 216 and the metal ion treatment 224 occur simultaneously. Alternatively, in some embodiments, the metal ion treatment 224 can be subsequent to the alkaline solution immersion 216, for example, by dissolving a metal in the alkaline solution only after the fiber(s) have been immersed therein, or by immersing the fiber(s) in a different alkaline solution containing the dissolved metal ions. In some embodiments, the alkaline concentration of the solution 216 and/or metal ion treatment 224 can be selected to allow the hydrogen bonds 212 to be broken while avoiding excessive swelling of the fiber that could inhibit effective bonding of the metal ions to the functional groups. At higher alkaline concentrations for the solution and/or metal ion treatment, the structure of the fiber may be compromised, for example, such that the fiber fails to recover the cellulose-I lattice structure upon drying. For example, when NaOH is used, the NaOH concentration in the alkaline solution 216 and/or the metal ion treatment 224 can be less than or equal to 15 wt % (e.g., in a range of 5-10 wt %, inclusive).

The metal 222 can be any metal capable of forming a coordination bond with the functional groups of the polymer molecular chains 210 and that exhibits an antimicrobial effect, for example, Cu, Zn, Au, Ag, and/or Ti. For example, when the polymer molecular chains 210 are formed of cellulose and the metal ions include Cu(II), the Cu ions can coordinate with the C2 and C3 hydroxyl groups on the cellulose chains, thereby forming stable Cu ion-cellulose complex. Alternatively or additionally, in some embodiments, the Cu ion can be coordinated with functional groups from two neighboring chains, thereby forming a three-dimensional cross-linked metal-organic framework. After the metal ion treatment 224, the metal ions 222 can maintain a spacing, W₂, between the polymer molecular chains 210 that is greater than the native spacing, W₁. In addition, the fiber can exhibit a new expanded lattice structure 220, for example, Na-cellulose-II(Cu).

Once the metal ions 222 are bonded between the polymer molecular chains 210, the fiber(s) can be immersed or rinsed with a solvent 218 (e.g., water), for example, to remove excess (e.g., unbound) metal ions and/or alkaline solution. In some embodiments, the solvent washing can be repeated multiple times and/or continuously, for example, until waste fluid from the washing exhibits a substantially neutral pH (e.g., about 7). After washing, the fiber(s) with metal ions 222 retained therein can then be subjected to a drying treatment 226, where the solvent molecules 218 (e.g., free water) are evaporated while preserving the nanostructure arrangement of the polymer molecular chains 210 and metal ions 222 to form an antimicrobial material. In some embodiments, the drying treatment 226 can be any type of drying, such as but not limited to air drying, vacuum drying, freeze drying, and critical point drying.

In some embodiments, after the drying treatment 226, the fiber(s) can have minimal or no free liquid therein, although there may otherwise be liquid molecules bound to the polymer molecular chains or other materials within the fiber(s). For example, the drying treatment 226 can be such that a total water content within the fiber(s) is less than or equal to 10 wt % (e.g., ≤8 wt %). In some embodiments, after the drying, the previously expanded lattice structure 220 (e.g., Na cellulose II(Cu)) can collapse such that the spacing W₃ between adjacent molecular chains 210 is less than W₂, and the original lattice structure 230 (e.g., cellulose-I) can be recovered (e.g., such that W₃≈W₁). As a result of the recovery of the original lattice structure 230, the fiber(s) can exhibit improved mechanical strength (e.g., tensile strength, abrasion resistance, etc.), for example, as compared to fibers treated with higher concentrations of alkaline solution (e.g., >15 wt % NaOH) that retain a cellulose-II lattice structure (at least in part) after washing and drying.

### Antimicrobial Material Examples

In some embodiments, an antimicrobial material can be formed by impregnating metal ions between cellulose molecular chains of cotton fibers, for example, woven together as a textile. For example, FIG. 3A illustrates the hierarchical microstructure of a cotton textile 320, similar to the hierarchical fiber-based microstructure of wood. Cellulose polymer chains 310 are derived from D-glucose monomers via the linkage of β-(1,4) glycosidic bonds and are typically bio-synthesized from cellulose synthase complex (CSC). The cellulose polymer chains 310 can form elementary fibrils 308 (e.g., 1.5-3.5 nm in diameter), which can further self-assemble into larger bundles of cellulose nanofibers 306 (e.g., having a nominal cross-sectional size of ~10 nm). These nanofibers 306 compose the cotton microfibers 302 (e.g., having a diameter of decadal micrometers).

Metal ions 304 (e.g., Cu(II)) can be incorporated into cotton fibers at the atomic level, for example, via strong coordination bonds 312 between the metal ions 304 and functional groups of the cellulose molecules 314. The coordination bonding between the metal ions 304 and their neighboring cellulose chains 310 can make the metal-ion-textile 320 highly stable in air and water, and durable against abrasion. Indeed, in some embodiments, such textiles 320 can exhibit improved mechanical properties as compared to unmodified textiles (e.g., a 23% increase in tensile strength), due at least in part to the role of metal ions 304 as “crosslinkers” between adjacent cellulose molecular chains 310. The strong bonding can also retain the metal ions within the fibers despite exposure to washing or other environmental conditions, such that the metal-ion-textile 320 can be used as clothing, soft furnishing, or other re-usable material. In addition to improved mechanical properties, the metal ions 304 incorporated into fibers 302 can exhibit antimicrobial effect, for example, by interacting with viral genomes (e.g., as shown at 336 in FIG. 3B), inhibiting virus replication (e.g., as shown at 334 in FIG. 3B), rupturing cell membranes of bacteria and/or fungi (e.g., as shown at 330 in FIG. 3B), and/or inducing reactive oxygen species (ROS) (e.g., as shown at 332 in FIG. 3B).

In FIGS. 3A-3B, metal ions are impregnated into a cotton textile; however, other cellulose-based materials and/or structures are also possible according to one or more contemplated embodiments. In some embodiments, the metal ions can be impregnated into fibers within or extracted from another fibrous plant material, such as wood, bamboo, or grass.

For example, natural wood has a unique three-dimensional porous microstructure comprising and/or defined by various interconnected cells. As shown in FIG. 3C, a hardwood microstructure 360 can have vessels 362 disposed within a hexagonal array of wood fiber cells 366 in a longitudinally-extending cell region. The vessels and fibers cells can extend along longitudinal direction, L, of the wood. Thus, the lumen of each vessel 362 can have an extension axis 364 that is substantially parallel to the longitudinal direction, L, and the lumen of each fiber cell 366 can have an extension axis 368 that is substantially parallel to the longitudinal direction, L. An intracellular lamella is disposed between the vessels 362 and fiber cells 366, and serves to interconnect the cells together. Softwoods can have a similar microstructure as that of hardwood, but with the vessels and wood fibers being replaced by tracheids that extend in the longitudinal direction, L, of the wood.

The cut direction of the original piece of wood can dictate the orientation of the cell lumina in the final structure. For example, in some embodiments, a piece of natural wood can be cut from a trunk 352 of tree 350 in a vertical or longitudinal direction (e.g., parallel to longitudinal wood growth direction, L) such that lumina of longitudinally-extending cells are oriented substantially parallel to a major face (e.g., largest surface area) of the longitudinal-cut wood piece 356. In the longitudinal-cut wood piece 356, the tangential direction, T, can be substantially perpendicular to the major face. Alternatively, in some embodiments, the piece of natural wood can be cut in a horizontal or radial direction (e.g., perpendicular to longitudinal wood growth direction, L) such that lumina of longitudinally-extending cells are oriented substantially perpendicular to the major face of the radial-cut wood piece 354. Alternatively, in some embodiments, the piece of natural wood can be cut in a rotation direction (e.g., perpendicular to the longitudinal wood growth direction L and along a circumferential direction of the trunk 352) such that lumina of longitudinal cells are oriented substantially parallel to the major face of the rotary-cut wood piece 358. In some embodiments, the piece of natural wood can be cut at any other orientation between longitudinal, radial, and rotary cuts.

In some embodiments, the cut orientation of the wood piece may dictate certain mechanical properties of the final processed wood (e.g., a load bearing direction for the final structure). In some embodiments, prior to or after incorporation of metal ions within the cellulose microstructure, the wood block can be subject to densification. In some embodiments, the wood block can be partially or fully delignified, or subjected to lignin modification, for example, to soften the microstructure prior to densification. For example, during a metal ion incorporation stage 363 as shown in FIG. 3D, a wood block 365 can be fully or partially immersed in an alkaline solution with dissolved metal ions therein. In some embodiments, the porous microstructure of the wood block 365 can allow the alkaline solution to reach interior portions thereof, for example, via the native lumina 367 formed by cellulose-based cell walls (e.g., a composite 369 of cellulose nanofibrils 370 bonded together by hemicellulose and lignin adhesive matrix 372, which is strong and rigid). As shown at 374 in FIG. 3D, the resulting wood block 376 can have a modified composite 378 with metal ions 380 incorporated within the cellulose nanofibrils 370. In some embodiments, the exposure to alkaline solution may also partially dissolve and/or modify lignin 382, for example, soften the microstructure.

After washing, the wood block 376 can be subjected to partial or full drying to form an antimicrobial material. Alternatively or additionally, in some embodiments, the wood block 376 can be densified, for example, to form a densified antimicrobial material 386 at stage 384 in FIG. 3D. For example, the wood block 376 can be densified by pressing along a direction substantially perpendicular to a longitudinal growth direction (L) of the wood. In some embodiments, a width, t₁, of the wood block 365 can be at least 2 times (e.g., at least 3-5 times) a width, t₂, of the densified antimicrobial material 386. In addition, the densified material can have an increased density as compared to the starting wood. For example, the densified antimicrobial material may have a density of at least 1.15 g/cm³ (e.g., at least 1.2 g/cm³, or at least 1.3 g/cm³), while the starting wood block may have a density less than 1.0 g/cm³ (e.g., less than 0.9 g/cm³, or less than 0.5 g/cm³). Alternatively, in some embodiments, the pressing for densification may be along a direction crossing the longitudinal growth direction or parallel to the longitudinal growth direction. In some embodiments, the pressing can substantially collapse the previously-open cellulose-based lumina 367, as shown at 388 in FIG. 3D. In some embodiments, the pressing can remove free water 390 from the wood block 376, for example, with or without a prior drying step.

In the examples of FIGS. 3A-3D, metal ions can be impregnated throughout the entire material. However, in some embodiments, metal ion impregnating may be restricted to one or more parts of the material. For example, FIG. 3E illustrates formation of an antimicrobial surface layer in a contiguous member 402 (e.g., block of fibrous plant material, such as wood or bamboo). During a metal ion infiltration stage 400, a surface portion 404 of the contiguous member 402 can be immersed or otherwise exposed to the alkaline solution with metal ions dissolved therein. After sufficient exposure, the contiguous member can be rinsed (e.g., to yield a neutral pH) and dried 406. The resulting structure can have an antimicrobial surface layer 408a (e.g., having metal ions incorporated into fibers) and an interior portion 408b with substantially no (or only minimal) metal ions.

Alternatively or additionally, in some embodiments, the antimicrobial material can be formed on, rather than in, a member. For example, FIG. 3F illustrates formation of an antimicrobial surface layer on a substrate 412 (e.g., a structural layer or base member such as but not limited to metal, wood, bamboo, and/or plastic). Cellulose fibers (e.g., extracted via mechanical and/or chemical fibrillation) can be immersed in an alkaline solution having dissolved metal ions therein, such that the metal ions become impregnated within the fibers and bonded to the cellulose molecular chains. In some embodiments, the cellulose fibers can then be rinsed to remove excess metal ions and/or the alkaline solution, and then dispersed in a solvent (e.g., water) to form a slurry. In the coating stage 410 of FIG. 3F, the slurry can be dispensed via a nozzle 414 onto a surface of substrate 412 to form a coating 416. Other coating techniques are also possible according to one or more contemplated embodiments, such as but not limited to dip coating, spin coating, spray coating, and doctor blade. The coated structure 418 can then be dried, thereby yielding a composite structure 420 formed by antimicrobial layer 422 on substrate 412.

Alternatively or additionally, in some embodiments, a separately formed antimicrobial material 428 can be attached to a substrate 426 (e.g., a structural layer or base member such as but not limited to metal, wood, bamboo, and/or plastic), as shown in FIG. 3G. The antimicrobial material 428 can be formed prior to the attachment stage 424, for example, using any of the techniques described above with respect to FIGS. 3A-3F or elsewhere herein. During the attachment stage 424, the antimicrobial material 428 can be disposed over and attached to an exposed surface of substrate 426, thereby yielding a composite structure 430. In some embodiments, a glue or other adhesive can be provided between the antimicrobial material 428 and substrate 426. Alternatively, in some embodiments, the antimicrobial material 428 may naturally adhere to the surface of the substrate 426, for example, via bonding (e.g., hydrogen bonding).

### Antimicrobial Material Methods

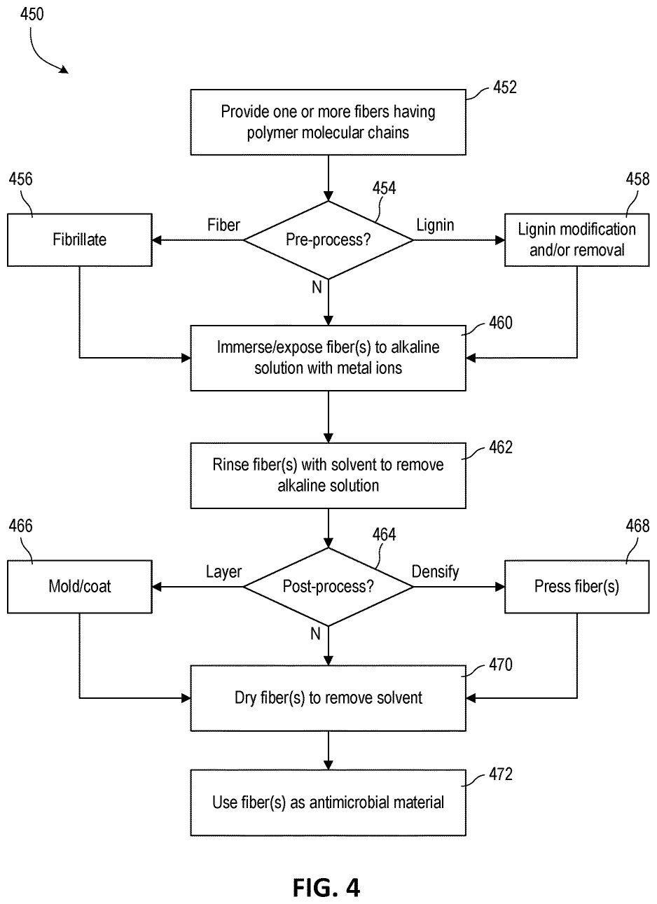

FIG. 4 shows an exemplary method 450 for fabricating and use of an antimicrobial material. The method 450 can begin at process block 452, where a starting material for the one or more fibers can be provided. As discussed above, the fiber(s) can be formed of cellulose. Alternatively, in some embodiments, elementary fibril(s) formed of another naturally-occurring polysaccharide can be used, for example, chitin or chitosan. In some embodiments, the providing of process block 452 can include obtaining the starting material including the fiber(s) (e.g., a block of wood, bamboo, or other fibrous plant; a pre-manufactured textile or paper; bacterial-produced cellulose fibers; mechanically or chemically extracted fibers; etc.). In some embodiments, the providing of process block 452 can also include preparing the starting material for metal-ion incorporation. For example, the preparing can include obtaining a pre-cut piece of wood with desired orientation or cutting a piece of wood to have a desired orientation (e.g., horizontal or rotational cutting perpendicular to the wood growth direction, vertical cutting parallel to the wood growth direction, and/or cutting at any angle crossing the wood growth direction). Alternatively or additionally, in some embodiments, the starting material may already be in fiber form, each fiber including a plurality of the elementary fibril(s), and the providing of process block 452 can include forming the starting material into a desired structure (e.g., paper, membrane, or a three-dimensional structure). For example, in some embodiments, a slurry containing the fibers can be formed into a paper (or other substantially planar structure) using vacuum filtration and pressing.

The method 450 can proceed to decision block 454, where it is determined if an optional pre-processing should be performed. In some embodiments, the pre-processing can include releasing the fibers from the starting material, in which case the method 450 can proceed from decision block 454 to process block 456. At process block 456, the mechanical fibrillation, chemical fibrillation, and/or other fibrillation means can be used to release and/or extract fiber(s) from the parent starting material. Alternatively or additionally, the elementary fibrils can be subjected to treatment with TEMPO, for example, to convert hydroxyl functional groups to carboxyl groups. Alternatively, in some embodiments, the elementary fibrils can be subjected to treatment with (3-chloro-2-hydroxylpropyl) trimethyl-ammonium chloride (CHPTAC), for example, to convert the surface charge of the functional groups from negative to positive.

Alternatively or additionally, in some embodiments, the pre-processing can include compromising native lignin (e.g., in wood or bamboo), in which case the method 450 can proceed from decision block 454 to process block 458. At process block 458, the lignin within the starting material (or a microstructure containing the fibers) can be partially removed, fully removed, or otherwise modified without removal.

For example, the lignin can be modified by first infiltrating the starting material (or microstructure) with one or more chemical solutions. For example, in some embodiments, the infiltration can be by soaking the plant material piece(s) in a solution containing the one or more chemicals under vacuum. In some embodiments, the chemical solution can contain at least one chemical component that has OH⁻ ions or is otherwise capable of producing OH⁻ ions in solution. In some embodiments, one, some, or all of the chemicals in the solution can be alkaline. In some embodiments, the chemical solution includes p-toluenesulfonic acid, NaOH, LiOH, KOH, Na₂O, or any combination thereof. Exemplary combinations of chemicals can include, but are not limited to, p-toluenesulfonic acid, NaOH, NaOH+Na₂SO₃/Na₂SO₄, NaOH+Na₂S, NaHSO₃+SO₂+H₂O, NaHSO₃+Na₂SO₃, NaOH+Na₂SO₃, NaOH/NaH₂O₃+AQ, NaOH/Na₂S+AQ, NaOH+Na₂SO₃+AQ, Na₂SO₃+NaOH+CH₃OH+AQ, NaHSO₃+SO₂+AQ, NaOH+Na₂Sx, where AQ is Anthraquinone, any of the foregoing with NaOH replaced by LiOH or KOH, or any combination of the foregoing. In some embodiments, the chemical infiltration can be performed without heating, e.g., at room temperature (20-30° C., such as ~22-23° C.). In some embodiments, the chemical solution is not agitated in order to avoid disruption to the native cellulose-based microstructure of the plant material piece(s). After chemical infiltration, the modification may be activated by subjecting the plant material piece(s) to an elevated temperature, for example, greater than 80° C. (e.g., 80-180° C., such as 120-160° C.), thereby resulting in softened plant material piece(s) (e.g., softened as compared to the natural plant material piece(s)).

Alternatively, if delignification is instead desired for process block 458, the plant material piece(s) can be subjected to one or more chemical treatments to remove at least some lignin therefrom, for example, by immersion of the plant material piece(s) (or portion(s) thereof) in a chemical solution associated with the treatment. In some embodiments, each chemical treatment or only some chemical treatments can be performed under vacuum, such that the solution(s) associated with the treatment is encouraged to fully penetrate the cell walls and lumina of the plant material piece(s). Alternatively, in some embodiments, the chemical treatment(s) can be performed under ambient pressure conditions or elevated pressure conditions (e.g., ~6-8 bar). In some embodiments, each chemical treatment or some chemical treatments can be performed at any temperature between ambient (e.g., ~23° C.) and an elevated temperature where the solution associated with the chemical treatment is boiling (e.g., ~70-160° C.). In some embodiments, the solution is not agitated in order to minimize the amount of disruption to the native cellulose-based microstructure of the plant material piece(s). The amount of time of immersion within the solution may be a function of the amount of lignin to be removed, type of plant material, size of the plant material piece, temperature of the solution, pressure of the treatment, and/or agitation.

In some embodiments, the solution of the chemical delignification treatment(s) can include sodium hydroxide (NaOH), lithium hydroxide (LiOH), potassium hydroxide (KOH), sodium sulfite (Na₂SO₃), sodium sulfide (Na₂S), NaₙS (where n is an integer), urea (CH₄N₂O), sodium bisulfite (NaHSO₃), sulfur dioxide (SO₂), anthraquinone (AQ) (C₁₄H₈O₂), methanol (CH₃OH), ethanol (C₂H₅OH), butanol (C₄H₉OH), formic acid (CH₂O₂), hydrogen peroxide (H₂O₂), acetic acid (CH₃COOH), butyric acid (C₄H₈O₂), peroxyformic acid (CH₂O₃), peroxyacetic acid (C₂H₄O₃), ammonia (NH₃), tosylic acid (p-TsOH), sodium hypochlorite (NaClO), sodium chlorite (NaClO₂), chlorine dioxide (ClO₂), chlorine (C₁₂), or any combination of the above. Exemplary combinations of chemicals for the chemical delignification treatment can include, but are not limited to, NaOH+Na₂SO₃, NaOH+Na₂S, NaOH+urea, NaHSO₃+SO₂+H₂O, NaHSO₃+Na₂SO₃, NaOH+Na₂SO₃, NaOH+AQ, NaOH+Na₂S+AQ, NaHSO₃+SO₂+H₂O+AQ, NaOH+Na₂SO₃+AQ, NaHSO₃+AQ, NaHSO₃+Na₂SO₃+AQ, Na₂SO₃+AQ, NaOH+Na₂S+NaₙS (where n is an integer), Na₂SO₃+NaOH+CH₃OH+AQ, C₂H₅OH+NaOH, CH₃OH+HCOOH, NH₃+H₂O, and NaClO₂+acetic acid.

After process blocks 456-458, or if no pre-processing was desired at decision block 454, the method 450 can proceed to process block 460, where metal ions can be impregnated within the fiber(s), for example, by immersing part or all of the fiber(s) in an alkaline solution having the metal ions dissolved therein. In some embodiments, process block 460 can include dissolving the metal ions in the alkaline solution prior to or during the immersion of the fiber(s). For example, the alkaline solution can include NaOH, KOH, LiOH, or combinations thereof, and the metal ion can be any metal capable of forming a coordination bond with the functional groups of the polymer molecular chains and exhibiting antimicrobial effect, for example, Cu, Zn, Au, Ag, and/or Ti. As described above, the immersion within the alkaline solution breaks the hydrogen bonds between functional groups (e.g., deprotonation), thereby allowing the polymer molecular chains of the elementary fibril(s) to open up. The metal ions can thus diffuse into the opened space between the polymer molecular chains and form coordination bonds to the exposed functional groups of adjacent molecular chains. In some embodiments, the metal ion impregnation of process block 460 is such that the metal ion content in the fiber(s) (or the final dried structure, e.g., the antimicrobial material) is at least 8 wt % (e.g., in a range of 8-13 wt %, inclusive).

In some embodiments, the immersion of process block 460 can be separated into at least two stages. For example, in a first stage, the fiber(s) can be immersed in a first alkaline solution without metal ions to break the hydrogen bonds and swell the material. In a subsequent second stage, the swelled fiber(s) can be immersed in a second alkaline solution with dissolved metal ions (or metal ions can be dissolved within the first alkaline solution) to form the metal-fiber complex.

In some embodiments, the immersion in the alkaline solution can temporarily convert the lattice structure of the fiber(s), for example, from cellulose-I to cellulose-II. Below a concentration threshold for the alkaline solution, the molecular structure of elementary fibrils may not be changed, and the metal ions may coordinate among the fibrils instead of within the fibrils (e.g., between polymer molecular chains). However, if the alkaline solution concentration is too high (e.g., >20 wt %), the lattice structure of the fiber(s) may become permanently converted to cellulose-II, which may result in a less stable or mechanically weaker structure after rinsing and drying. Thus, in some embodiments, the concentration of the alkaline solution during process block 460 can be selected to avoid over-swelling the fiber(s). For example, when using NaOH, the concentration can be less than 15 wt % (e.g., in a range of 5-10 wt %).

The method 450 can proceed to process block 462, where rinsing can be performed. For example, the rinsing can be used to remove residual chemicals (e.g., alkaline solution) and/or particulate(s) (e.g., excess or unbound metal ions) from the fiber(s). For example, the fiber(s) can be partially or fully immersed in one or more rinsing solutions. The rinsing solution can be a solvent, such as but not limited to, de-ionized (DI) water, alcohol (e.g., ethanol, methanol, isopropanol, etc.), or any combination thereof. In some embodiments, the rinsing may be repeated multiple times (e.g., at least 3 times) using a fresh mixture rinsing solution for each iteration, or until a substantially neutral pH is measured for waste fluid from the fiber(s).

The method 450 can proceed to decision block 464, where it is determined if an optional post-processing should be performed. In some embodiments, the post-processing can include forming the fiber(s) with metal ions impregnated therein as a layer, in which case the method 450 can proceed from decision block 464 to process block 466. For example, the metal-ion-fiber(s) can be maintained in solution (e.g., water) to form a slurry. At process block 466, the slurry can be poured into a mold or coated on a surface.

Alternatively or additionally, in some embodiments, the post-processing can include densifying the fiber(s) with metal ions impregnated therein to form a densified structure, in which case the method 450 can proceed to process block 468. For example, the metal-ion-fiber(s) can be pressed in a direction crossing its longitudinal direction. In some embodiments, the pressing may be performed without any prior drying of the fiber(s) or with the fiber(s) retaining at least some water or other fluid therein after partial drying. The pressing can thus be effective to remove at least some water (or other fluid) from the fiber(s) at the same time as its dimension is reduced and density increased. In some embodiments, the pressing can encourage hydrogen bond formation between adjacent fibers, which can improve mechanical properties of an antimicrobial material comprising the fibers. Moreover, the metal ions impregnated within the fiber(s) are retained after the pressing.

The pressure and timing of the pressing can be a factor of the size of plant material piece(s) prior to pressing, the desired size of the fiber(s) after pressing, the water or fluid content within the fiber(s) (if any), the temperature at which the pressing is performed, relative humidity, and/or other factors. For example, the fiber(s) can be held under pressure for a time period of 1 minute up to several hours (e.g., 1 minute to 72 hours, inclusive). In some embodiments, the pressing can be performed at a pressure between 0.5 MPa and 20 MPa, inclusive, for example, 5 MPa. In some embodiments the pressing may be performed without heating (e.g., cold pressing), while in other embodiments the pressing may be performed with heating (e.g., hot pressing). For example, the pressing may be performed at a temperature between 20° C. and 160° C., e.g., greater than or equal to 100° C. In some embodiments, the pressing can be effective to fully collapse the lumina of the native cellulose-based microstructure of the plant material and/or can result in a density for the compressed plant material of at least 1 g/cm³ (e.g., ≥1.15 g/cm³ or ≥1.3 g/cm³, for example, in a range of 1.4-1.5 g/cm³).

In the illustrated example of FIG. 4, the pressing of process block 468 and the molding/coating of process block 466 occur after metal ion impregnation in process block 460. However, embodiments of the disclosed subject matter are not limited thereto. Rather, in some embodiments, process block 468 can occur prior to the metal ion impregnation of process block 460 and/or the rinsing of process block 462. Similarly, in some embodiments, process block 466 can occur prior to the metal ion impregnation of process block 460 and/or the rinsing of process block 462.

After process blocks 460-462 and 466-468, or if no post-processing was desired at decision block 464, the method 450 can proceed to process block 470, where the fiber(s) can be dried to remove free liquid (e.g., solvent, such as water) therefrom and thus form the antimicrobial material. For example, the drying can be effective to evaporate free liquid from the fiber(s), thereby maintaining the nanostructure of the elementary fibril(s), e.g., with the metal coordination bonds between the polymer molecular chains. In some embodiments, the drying of process block 470 can be effective to remove all or most of free water from the fiber(s). For example, total water within the dried fiber(s) can be less than or equal to 10 wt % (e.g., in a range of 3-8 wt %). The drying of process block 470 can include air drying, vacuum drying, freeze drying, and/or critical point drying. In some embodiments, the drying of process block 470 may be omitted, for example, when the pressing of process block 468 is otherwise sufficient to remove the free liquid from the fiber(s).

The method 450 can proceed to process block 472, where the dried fiber(s) can be used as an antimicrobial material. For example, one or more microbes can be exposed (directly or indirectly) to the antimicrobial material so as to kill the microbe(s) and/or inhibit replication of the microbe(s). In some embodiments, the one or more microbes can include a virus, a bacteria, a fungus, or a protozoa, and the antimicrobial material can act as an antiviral agent, an antibacterial agent, an antifungal agent, an antiprotozoal agent, or any combination thereof.

Although blocks 452-472 of method 450 have been described as being performed once, in some embodiments, multiple repetitions of a particular process block may be employed before proceeding to the next decision block or process block. In addition, although blocks 452-472 of method 450 have been separately illustrated and described, in some embodiments, process blocks may be combined and performed together (simultaneously or sequentially). Moreover, although FIG. 4 illustrates a particular order for blocks 452-472, embodiments of the disclosed subject matter are not limited thereto. Indeed, in certain embodiments, the blocks may occur in a different order than illustrated or simultaneously with other blocks. In some embodiments, method 450 can include steps or other aspects not specifically illustrated in FIG. 4. Alternatively or additionally, in some embodiments, method 450 may comprise only some of blocks 452-472 of FIG. 4.

### Fabrication System Examples

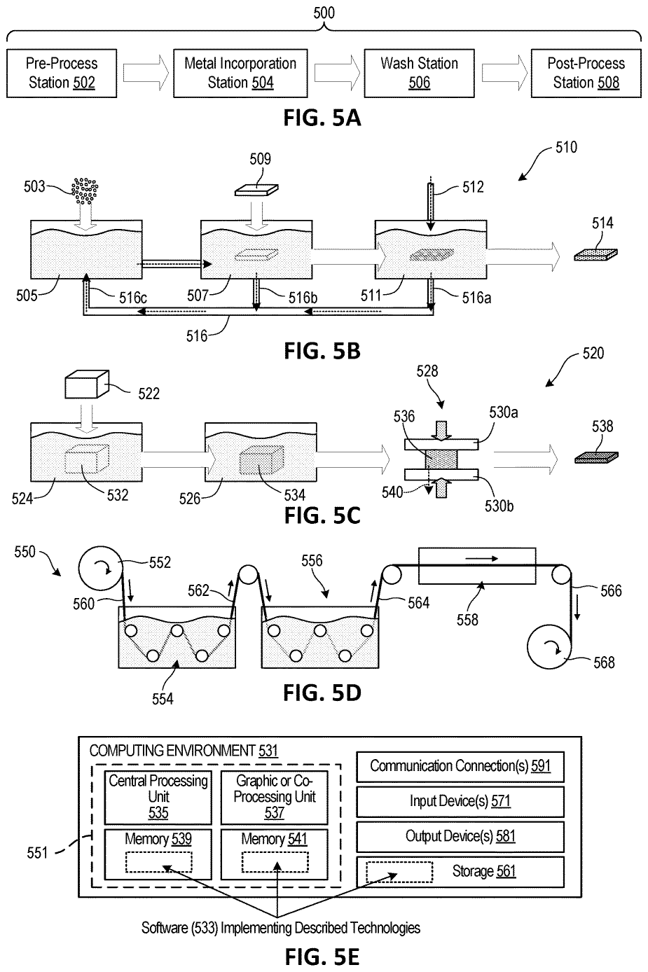

FIG. 5A shows aspects of an antimicrobial fabrication system 500 according to one or more embodiments. In the illustrated example, the fabrication system 500 includes a pre-processing station 502, a metal ion incorporation station 504, a wash station 506, and a post-processing station 508. One or more transport mechanisms (e.g., conveyor belts, not shown) can be provided to move material between each station. The pre-processing station 502 can be configured to prepare the fibers, or a material having the fibers, for subsequent metal ion incorporation. In some embodiments, the pre-processing station 502 can extract or release the fibers from a parent material, for example, via mechanical or chemical fibrillation. Alternatively or additionally, the pre-processing station 502 can subject the material having the fibers therein to partial or full delignification, for example, via one or more chemical treatments. Alternatively or additionally, the pre-processing station 502 can subject the material having the fibers therein to lignin modification, for example, via one or more chemical treatments.

The metal ion incorporation station 504 can expose the fibers, or a material having the fibers, to an alkaline solution having metal ions dissolved therein, such that the metal ions become impregnated within the fibers (e.g., bonded between adjacent polymer molecular chains). The wash station 506 can rinse the fibers, or a material having the fibers, with solvent (e.g., water) to remove alkaline residue and/or excess metal ions. The post-processing station 508 can be configured to dry the rinsed fibers, or the rinsed material having the fibers, for example, via air drying, vacuum drying, critical point drying, and/or freeze drying. Alternatively or additionally, the post-processing station 508 can perform molding or coating, for example, using a slurry formed by the fibers in solution. Alternatively or additionally, the post-processing station 508 can perform densification, for example, by pressing the fibers or the material having the fibers.

In some embodiments, a fabrication system may include one, some, or all of the stations illustrated in FIG. 5A, for example, only stations 504-506 (e.g., when pre-processing is not needed, or is performed elsewhere). Alternatively or additionally, in some embodiments, functions performed by one, some, or all of the stations illustrated in FIG. 5A can be combined together in a single station (e.g., with metal ion impregnation and washing being performed in a single station). Alternatively or additionally, functions performed by one illustrated station can be repeated by multiple stations or substations (e.g., multiple sequential washing stations) or distributed across multiple stations or substations (e.g., with alkaline solution exposure occurring in a first substation and metal-ion-saturated alkaline solution exposure occurring in a second substation). Other variations are also possible according to one or more contemplated embodiments.

Referring to FIG. 5B, another system 510 for fabricating an antimicrobial material 514 is shown. In the illustrated example, the system 510 has a reserve tank 505, a reaction tank 507, and a washing tank 511. Metal ions 503 can be added to alkaline solution in the reserve tank 505 to form a metal-ion-saturated alkaline solution. The metal-ion-saturated alkaline solution can be dispensed to the reaction tank 507 on as needed basis, for example, to replenish metal ions consumed via the impregnation into fibers of raw material 509 (e.g., textile, paper, wood, bamboo, etc.). Once sufficient metal ions have been impregnated, the material can be transported (e.g., via a conveyor system, not shown) to washing tank 511, where a solvent (e.g., water) can rinse away the alkaline agent and any excess metal ions. Subsequent drying of the washed material can yield the desired antimicrobial material 514.

In some embodiments, the excess metal ions and/or alkaline solution can be recovered for re-use, for example, via recycle line 516. For example, metal ions and alkaline agent in washing tank 511 can be captured and output to the recycle line 516 via outlet stream 516a. Fresh liquid 512 (e.g., water) can be added to washing tank 511 to compensate for any volume lost to recycle line 516 and/or to adjust pH within the washing tank 511 (e.g., to maintain a substantially neutral pH). Alternatively or additionally, metal ions and alkaline agent in reaction tank 507 can also be captured and output to the recycle line 516 via outlet stream 516b. Recycle line 516 can convey the captured metal ions and alkaline agent back to the reserve tank 505 via inlet stream 516c for reuse. Such recycling may allow the system to operate in a more cost-effective and sustainable manner.

In some embodiments, the fabrication system can form a densified structure with antimicrobial properties. For example, FIG. 5C illustrates a system 520 for fabricating a densified antimicrobial material 538. In the illustrated example, a block 522 of fibrous plant material (e.g., wood or bamboo, with native lignin, modified lignin, or delignified), can be immersed in an alkaline solution 524 having metal ions dissolved therein, so as to form a metal-ion block 532 (e.g., with metal ions embedded within the fibers of the fibrous plant material). The metal-ion block 534 can then be immersed in one or more solvent washes 526 (e.g., water). After washing, the metal-ion block 536 can be transported to a densification stage 528, for example, where one or more platens 530a, 530b can compress the metal-ion block 536 along at least one dimension, thereby yielding the final antimicrobial material 538. In some embodiments, the compression in the densification stage 528 can be effective to remove free liquid 540 (e.g., water) from the metal-ion block 536.

In some embodiments, the fabrication system can form the antimicrobial material in a substantially continuous fashion, for example, by processing sequential portions of a continuous or elongated textile, paper, or veneer. For example, FIG. 5D illustrates a fabrication system 550 employing a roll-to-roll configuration for processing a fibrous plant material (e.g., cotton fabric). In the illustrated example, a supply roll 552 (e.g., motorized or passive) can dispense fibrous plant material 560 into a metal impregnation station 554 (e.g., having a bath of metal-ion-saturated alkaline solution). One or more rollers (e.g., motorized or passive) can move the fibrous plant material through the metal impregnation station 554, for example, such that the speed of the fibrous plant material corresponds to a sufficient or desired dwell time within the bath to yield metal ion impregnation.

The metal-ion-impregnated fibrous plant material 562 exiting the metal impregnation station 554 can be directed via one or more rollers (e.g., motorized or passive) to washing station 556 (e.g., having a bath of solvent, e.g., water). One or more rollers (e.g., motorized or passive) can move the metal-ion-impregnated fibrous plant material through the washing station 556, for example, such that the speed of the fibrous plant material corresponds to a sufficient or desired dwell time within the bath to rinse away the alkaline agent. The now rinsed, metal-ion-impregnated fibrous plant material 564 exiting the washing station 556 can be directed via one or more rollers (e.g., motorized or passive) to drying station 558 (e.g., having conductive, convective, and/or radiative heating elements). One or more rollers (e.g., motorized or passive) can move the metal-ion impregnated fibrous plant material through the drying station 558, for example, such that the speed of the fibrous plant material corresponds to a sufficient or desired dwell time to dry the material. The resulting antimicrobial material 566 can be directed via one or more rollers (e.g., motorized or passive) for collection by storage roll 568 (e.g., motorized of passive).

### Computer Implementation Examples

FIG. 5E depicts a generalized example of a suitable computing environment 531 in which the described innovations may be implemented, such as but not limited to aspects of system 500 (e.g., a control system thereof), system 510 (e.g., a control system thereof), system 520 (e.g., a control system thereof), system 550 (e.g., a control system thereof), and/or method 450. The computing environment 531 is not intended to suggest any limitation as to scope of use or functionality, as the innovations may be implemented in diverse general-purpose or special-purpose computing systems. For example, the computing environment 531 can be any of a variety of computing devices (e.g., desktop computer, laptop computer, server computer, tablet computer, etc.).

With reference to FIG. 5E, the computing environment 531 includes one or more processing units 535, 537 and memory 539, 541. In FIG. 5E, this basic configuration 551 is included within a dashed line. The processing units 535, 537 execute computer-executable instructions. A processing unit can be a central processing unit (CPU), processor in an application-specific integrated circuit (ASIC), or any other type of processor (e.g., hardware processors, graphics processing units (GPUs), virtual processors, etc.). In a multi-processing system, multiple processing units execute computer-executable instructions to increase processing power. For example, FIG. 5E shows a central processing unit 535 as well as a graphics processing unit or co-processing unit 537. The tangible memory 539, 541 may be volatile memory (e.g., registers, cache, RAM), non-volatile memory (e.g., ROM, EEPROM, flash memory, etc.), or some combination of the two, accessible by the processing unit(s). The memory 539, 541 stores software 533 implementing one or more innovations described herein, in the form of computer-executable instructions suitable for execution by the processing unit(s).

A computing system may have additional features. For example, the computing environment 531 includes storage 561, one or more input devices 571, one or more output devices 581, and one or more communication connections 591. An interconnection mechanism (not shown) such as a bus, controller, or network interconnects the components of the computing environment 531. Typically, operating system software (not shown) provides an operating environment for other software executing in the computing environment 531, and coordinates activities of the components of the computing environment 531.

The tangible storage 561 may be removable or non-removable, and includes magnetic disks, magnetic tapes or cassettes, CD-ROMs, DVDs, or any other medium which can be used to store information in a non-transitory way, and which can be accessed within the computing environment 531. The storage 561 can store instructions for the software 533 implementing one or more innovations described herein.

The input device(s) 571 may be a touch input device such as a keyboard, mouse, pen, or trackball, a voice input device, a scanning device, or another device that provides input to the computing environment 531. The output device(s) 581 may be a display, printer, speaker, CD-writer, or another device that provides output from computing environment 531.

The communication connection(s) 591 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or any other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java™, Python®, and/or any other suitable computer language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### Fabricated Examples and Experimental Results

Copper ion textiles (Cu-IT) were fabricated using a simple setup and inexpensive chemicals. First, Cu(II)-saturated NaOH aqueous solution was prepared by immersing copper wires in the NaOH solutions (NaOH dissolved in deionized (DI) water) until no further darkening of the blue color was observed (typically in less than 2 days). A piece of cotton textile (20 cm×8 cm) was then immersed in the blue-colored Cu(II)-saturated aqueous NaOH solution until no further color change was observed in the fabric (stable blue color, typically in 3 days). Then, the blue-colored textile was taken out and washed with DI water to remove residual NaOH and excess Cu(II) ions, in particular, until the waste fluid exhibited a pH of about 7. Finally, the textile was dried at room temperature in preparation for use.

Control parameters of the fabrication process included the NaOH concentration and soaking time. The influence of the NaOH concentration on the Cu(II) ion coordination was investigated. Four Cu(II)-saturated NaOH aqueous solutions of equal volume but of different NaOH concentrations (5%, 10%, 20% and 40% by weight) were prepared, and four pieces of cotton textile strips of the same size were soaked in the respective solutions. For the samples soaked in the 5 wt % and 10 wt % NaOH solutions, the color of the textiles changed to dark blue within one day, while the sample soaked in the 40 wt % NaOH solution exhibited uneven blue color even after eight days of soaking. Without being bound by any particular theory, it is believed that the high concentration of the 40 wt % NaOH solution may overly swell the cellulose matrix, thereby failing to provide a suitable chemical environment for Cu ion coordination.

Moreover, at lower concentrations (e.g., ≤15 wt %), the NaOH solutions have a viscosity close to that of water (e.g., 1.31 mPa·s and 1.86 mPa·s for the 5% and 10% NaOH solutions, respectively, compared to 1.0 mPa·s for water at 20° C.). As the NaOH concentration increases, the viscosity continues to increase; for example, for 20 wt % and 40 wt % NaOH solutions, the viscosities are 4.4 mPa·s and 38.1 mPa·s, respectively. Without being bound by any particular theory, it is believed that such higher viscosities can prevent, or at least inhibit, adequate diffusion of Cu ions into the fiber microstructure.

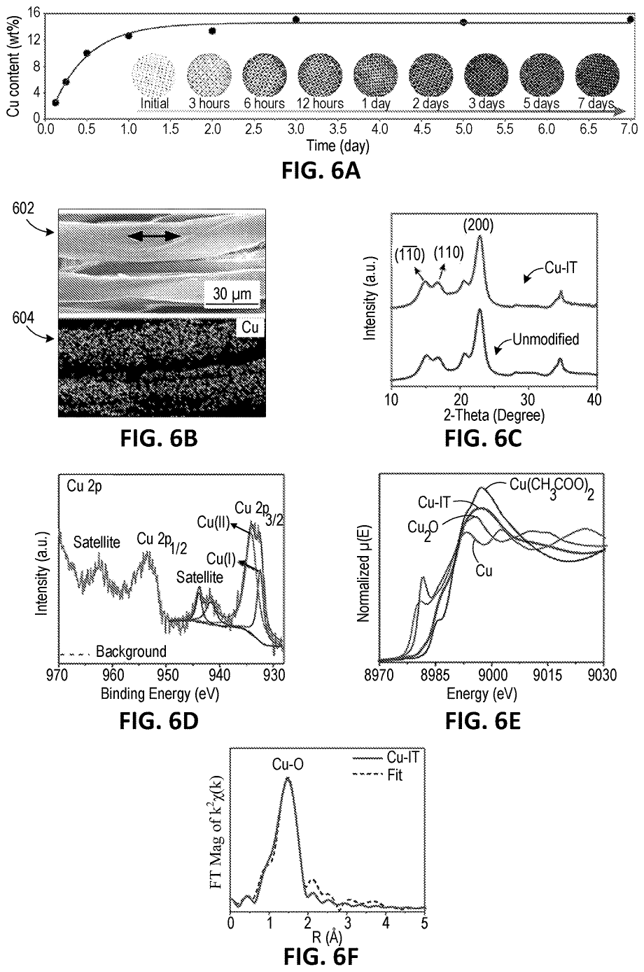

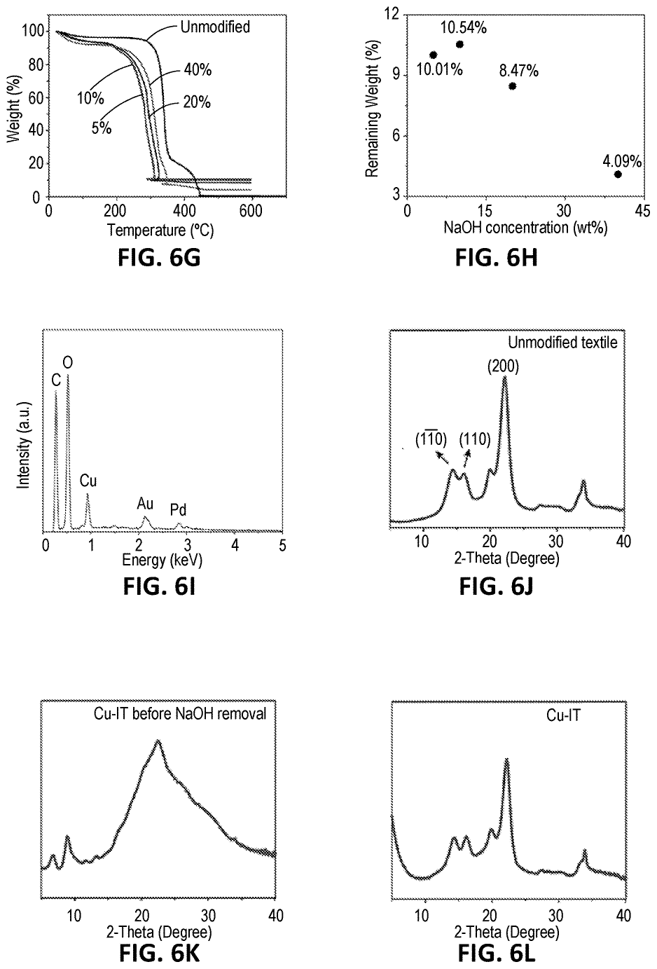

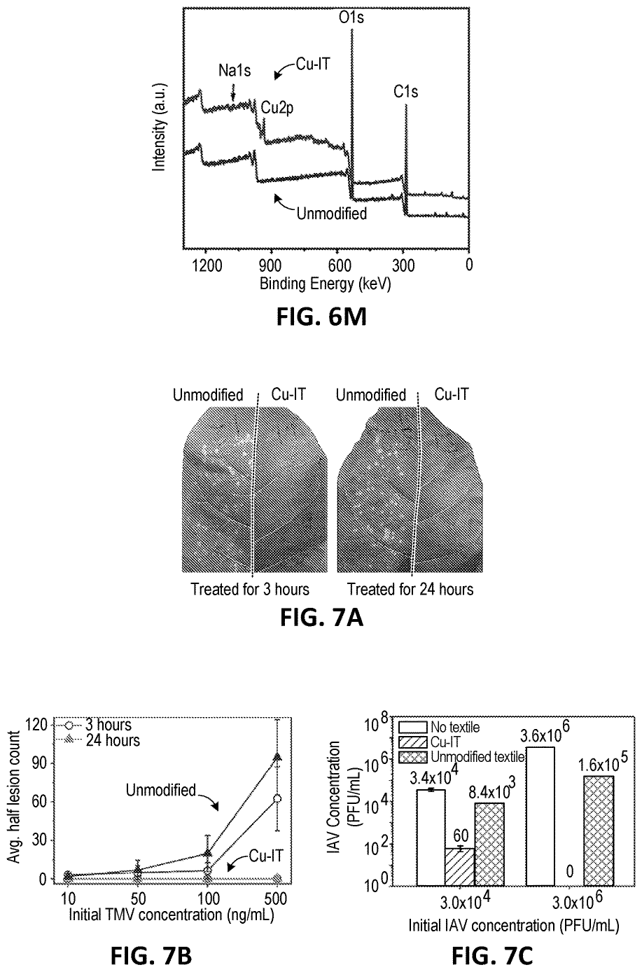

The four samples were then washed to a near-neutral condition with DI water and vacuum dried for thermogravimetric analysis (TGA) to determine the Cu content. The TGA tests of the cotton textile samples were performed at a heating rate of 5° C./min in air. As shown by the TGA trace for an unmodified cotton textile in FIG. 6G, the cellulose molecules can be completely decomposed at about 450° C. For the Cu-IT samples, assuming that the cellulose is completely decomposed and the remaining weight is attributed to the formed CuO, the Cu content can be calculated using the following equation:

$$Cu content ( \% ) = \frac{w \times M ( Cu )}{M ( CuO )} = 0.8 w$$

where w is the remaining weight percentage (wt %) after the TGA test (per FIG. 6H), and M(Cu) and M(CuO) are the molecular weights of Cu and CuO, respectively. Based on the TGA results, the sample treated with the 10 wt % NaOH solution has the highest Cu content of
8.43 wt %. Accordingly, 10 wt % NaOH solution was used to fabricate Cu-IT samples, unless otherwise noted below. The influence of soaking time on the Cu(II) ion coordination was separately investigated. As shown in FIG. 6A, the Cu content initially increased with the soaking time and plateaued at 12.64 wt % after soaking for one day.

Scanning electron microscopy (SEM) of the textiles confirmed that the Cu(II)-saturated NaOH solution did not change the morphology of the textiles, and that no particles could be observed on the surfaces of the cellulose microfibers (as evidenced by the SEM image 602 of FIG. 6B) or constituent nanofibers of the Cu-IT (indicating the absence of Cu salts or oxides). Energy dispersive spectroscopy (EDS) was used to confirm the uniform distribution of Cu throughout the cellulose microfibers, as shown by the elemental mapping 604 of FIG. 6B and FIG. 6I. Additionally, no Na was observed in the EDS spectrum of FIG. 6I, suggesting that NaOH has been thoroughly removed during the washing process. Finally, the cross-sectional morphology and Cu mapping of the microfibers (via SEM imaging and EDS analysis) confirmed the well-preserved microstructures of the cotton fibers and even distribution of the Cu ions throughout the fibers. Infiltrating Cu ions into the microfibers thus leads to more homogeneous distribution of Cu compared to prior antimicrobial cotton fabrics, in which Cu particles were deposited on the fiber surfaces.

During soaking in the Cu(II)-saturated NaOH solution, the textile undergoes two processes. First, the alkaline environment effectively disrupts the existing hydrogen bonding networks, resulting in a swollen cellulose matrix. During this first process, the crystal structure of cellulose changes from cellulose-I (with parallel chain packing) to cellulose-II (with antiparallel packing). Next, the Cu(II) ions can diffuse into the cellulose crystals and the gaps between crystals to coordinate with O atoms of the hydroxyl groups on the cellulose chains. Such molecular conformations and packing modes provide optimal geometries for Cu coordination to form a new crystal structure, Na-cellulose II(Cu), as verified by the X-ray diffraction (XRD) analysis of FIGS. 6J-6L. After removing NaOH by washing with DI water and drying, the expanded Na-cellulose II(Cu) lattices collapse, and the cellulose-I lattices are recovered. This recovery of cellulose-I lattices after washing and drying is shown by the resemblance between the XRD patterns of the unmodified textile and Cu-IT in FIG. 6C. Moreover, no signature diffraction peaks associated with new crystal structures (e.g., Na-cellulose II(Cu)) are observed.

After drying to form the Cu-IT, the Cu ions remain trapped between the unit cells of cellulose crystals, as confirmed by experiments. In particular, the results from X-ray photoelectron spectroscopy (XPS) confirm the presence of Cu species in the Cu-IT. The Cu 2p XPS spectrum of the Cu-IT in FIG. 6D shows a Cu 2p3/2 peak at 933.4 eV and an apparent satellite peak at 943 eV, indicating a mixed Cu(I) and Cu(II) state. The appearance of a small amount of Cu(I) may be attributed to the weak reducing ability of cellulose. Comparison of the XPS spectra in FIG. 6M further shows that no Na signal was detected in the final Cu-IT, consistent with the EDS results of the Cu-IT, thus confirming that NaOH has been completely removed. The coordinated state of Cu ions in the Cu-IT textile was also verified by X-ray absorption spectroscopy (XAS). In FIG. 6E, the Cu K-edge X-ray absorption near-edge structure (XANES) spectrum of the Cu-IT shows a broadened characteristic Cu(II) signature. A first-shell Cu—O bonding featuring a distance of 1.93 Å and a Cu coordination number of 4.0 were determined by fitting the extended X-ray absorption fine structure (EXAFS) spectrum of the Cu-IT (FIG. 6F). These spectroscopic findings, along with the results from calorimetric experiments and macroscopic properties (e.g., the stable color), indicate that Cu ions are trapped in the cellulose matrix and stabilized via coordination bonding.

The antiviral and antibacterial properties of the Cu-IT were subsequently tested. Tobacco mosaic virus (TMV) and Influenza A virus (IAV) were used as model viruses, and E. coli, S. typhimurium, P. aeruginosa, and B. subtilis were used as model bacteria. The viral or bacterial strains were first incubated in the presence of the unmodified cotton textile control or Cu-IT (both textiles were sterilized before use). Then, the viruses and bacteria were inoculated on appropriate mediums to test the viral infectivity and bacterial viability.

In particular, to assess the antiviral capabilities against TMV, the textile samples were incubated in TMV solutions in pH 7.4 phosphate buffered saline (PBS), ranging from 0-500 ng/mL. Samples of TMV solution were taken at 3 and 24 hours of incubation and were kept at −20° C. Half-leaf assays were performed as described in Padmanabhan et al., “Tobacco mosaic virus replicase-auxin/indole acetic acid protein interactions: reprogramming the auxin response pathway to enhance virus infection,” Journal of Virology, 2008, 82: pp. 2477-85, which assay description is incorporated by reference herein. In an example, leaves of ~6-8 week old Nicotiana tabaccum cv. Xanthi nc. plants were dusted with carborundum, and half of each leaf was inoculated with 20 μl of the TMV solution sample that was incubated with the presence of Cu-IT, while the other half of the leaf was inoculated with a TMV control solution of the same concentration that was incubated with the unmodified textile. Plants were grown for an additional 5 days and local lesions corresponding to TMV infection foci were counted. The number of lesions on the leaf after 5 days of plant growth was counted as a measure of the TMV infectivity.

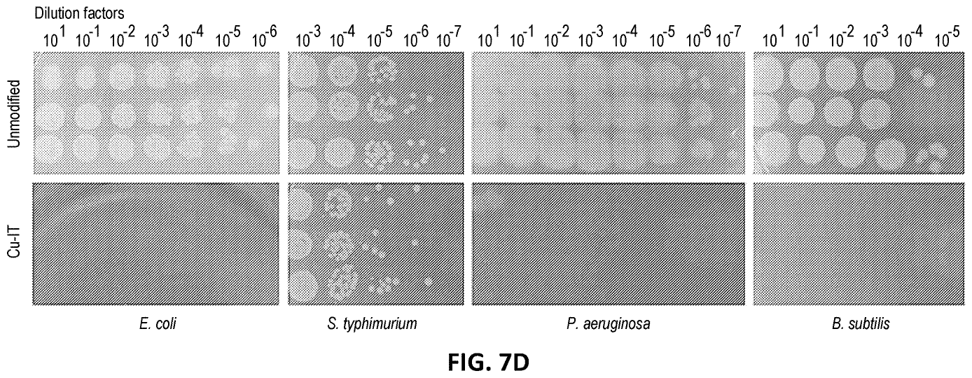

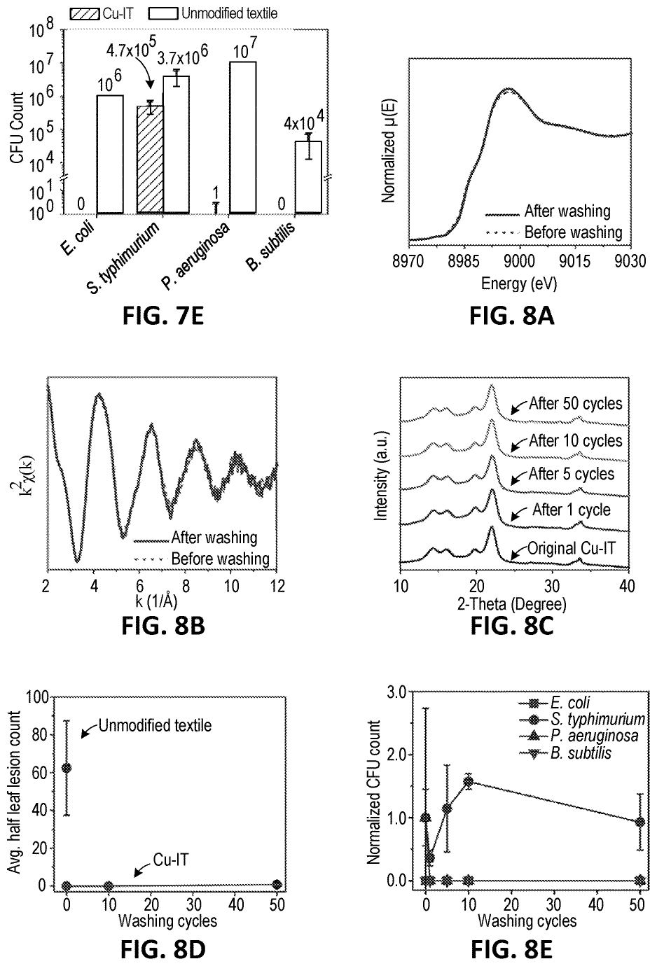

As shown in FIG. 7A, the Cu-IT shows excellent antiviral activity against TMV. In particular, FIG. 7A shows photographs of the inoculated (with an initial TMV concentration of 500 ng/mL, a highly infectious dose) Nicotiana tabaccum leaves (after 5 days). The leaf on the left was inoculated with TMV being treated using Cu-IT or unmodified textile for 3 hours, and the one on the right with TMV being treated for 24 hours. No lesions are observed on the halves inoculated with Cu-IT-treated TMV and a 3 hour-treatment is sufficient for the Cu-IT to take effect (left leaf in FIG. 7A). In contrast, a large number of lesions are observed on the halves inoculated with the unmodified textile-treated TMV and the lesion count is higher for TMV treated for 24 hours. FIG. 7B shows a quantitative analysis of the lesion count variation versus the initial TMV solution concentration as well as the time for unmodified textile or Cu-IT treatment (3 h and 24 h). The Nicotiana tabaccum leaves inoculated with Cu-IT-treated TMV yield zero counts under all conditions. These results indicate that the TMV infectivity can be effectively inhibited after exposure to the Cu-IT for a period as short as 3 hours. Considering that TMV shows very high stability under various conditions, the Cu-IT demonstrates strong potential for use as an antiviral material with high efficacy against a broader range of virus strains.

To assess the antiviral capabilities against IAV, the Puerto Rico/8/34 IAV strain was propagated in Madin-Darby canine kidney (MDCK) cells. The virus stock was used as a high concentration virus solution (~3×10⁶ PFU/mL) or diluted in Dulbecco's phosphate buffered saline (DPBS) containing 0.1% bovine serum albumin (BSA) to a lower concentration (~3×10⁴ PFU/mL). Textile samples were incubated in 500 μL of high or low concentration IAV solution at room temperature for 30 min. Virus-containing supernatants were recovered and stored at −80° C. until further analyses. Plaque assays were carried out using MDCK cells as described in Jalily et al., “Mechanisms of action of novel influenze A/M2 viroporin inhibitors derived from hexamethylene amiloride,” Molecular Pharmacology, 2016, 90: pp. 80-95, which assay description is incorporated by reference herein. Briefly, virus solutions incubated with and without Cu-IT were serially diluted in Dulbecco's Modified Eagle Medium (DMEM) containing 1.5 μg/mL TPCK-treated trypsin and no serum, and 100 μL of each dilution was inoculated on confluent MDCK cells in 12-well plates. Following a 1-hour adsorption at 37° C., cells were washed twice with DPBS and overlaid with DMEM containing 1% SeaPlaque agarose, 10 mM HEPES buffer, 1.5 μg/mL TPCK-treated trypsin, 100 U/mL penicillin, and 100 mg/mL streptomycin. After incubation at 37° C. in 5% CO₂ for 3 days, cells were stained with 0.01% neutral red to allow plaque visualization and counting. Plaque forming units (PFU) per milliliter in the undiluted solutions were calculated by multiplying number of plaques by the dilution factors.

As shown in FIG. 7C, when the Cu-IT was incubated with a low concentration of IAV solution (~3×10⁴ PFU/mL), the infectivity reduced significantly (e.g., 567-times lower than the IAV solution incubated with no textile). In contrast, IAV incubated with the unmodified textile also resulted in a decrease in infectivity, but far less (e.g., 4-fold). Moreover, when the Cu-IT was incubated with a high concentration of the IAV solution (~3×10⁶ PFU/mL), no plaque was found, while a low decrease of infectivity (22.5-fold) was measured for the unmodified textile. It is believed that 60 PFU/mL result for the low concentration of IAV solution incubated with Cu-IT in FIG. 7C was caused by either cross contamination or stochastic effect due to very low virus titer. The Cu-IT was re-tested with and without wash by focus assay, and no foci were found. These results demonstrate the Cu-IT's superior inhibitory activity against IAV.

For the antibacterial assessment, cell viability was measured by replicate plating of bacterial cultures (treated with the unmodified textile or Cu-IT) onto Luria-Bertani broth (LB) agar, and the agar plates were then counted for colonies after incubation overnight (see Methods for details). In particular, E. coli SW101, S. typhimurium, P. aeruginosa, and B. subtilis seed cultures were prepared overnight in LB media at 37° C. and 250 RPM shaking. Overnight cultures were then diluted to approximately 0.1 OD₆₀₀ (optical density at 600 nm) in M9 minimal media with 0.4% glucose and 0.4% casamino acids for E. coli SW101, S. typhimurium, and P. aeruginosa, and M9 minimal media with 0.4% glucose, 0.4% casamino acids, and 0.1% tryptophan for B. subtilis. 2 mL of the diluted cultures were then plated per well in a 12-well culture plate along with a textile sample. The cultures were then incubated at 37° C. and 250 RPM shaking for 3 hours. Bacteria cultures were sampled after 3 hours and were serially diluted 10-fold. 5 μL of each serial dilution was then plated per dilution in triplicate onto LB agar. After overnight incubation at 37° C., the plates were imaged and manually counted for colony-forming units.

As shown in FIG. 7D, the colony numbers for the Cu-IT-treated bacterial cultures (for all four strains, including the Gram-negative bacterium: E. coli, S. typhimurium, P. aeruginosa, and the Gram-positive bacterium: B. subtilis) were significantly lower than those for the unmodified textile-treated cultures. These results were quantified using colony-forming units (CFU) counts, and as shown in FIG. 7E, the viable cell counts in the Cu-IT-treated cultures of E. coli, S. typhimurium, P. aeruginosa, and B. subtilis were 1,000,000-, 8-, 10,000,000-, and 40,000-times lower, as compared with those in the unmodified textile-treated cultures. Varied bacteriostatic activities were observed for the four bacterial strains, which may be due to the differences in their cell membrane structures as well as their response to Cu-induced ROS.

To study the biocompatibility of Cu-IT with human skin, cytotoxicity assessment was performed using artificial perspiration on human dermal fibroblasts. In particular, primary human dermal fibroblasts (PCS-201-012, ATCC) were cultured in fibroblast basal medium (PCS-201-030, ATCC) supplemented with the Fibroblast Growth Kit, Low Serum (PCS-201-041, ATCC), and 1% (v/v) penicillin/streptomycin (P/S, Gibco), and were incubated in a humidified atmosphere at 37° C. and 5% CO₂. A piece of the textile sample of 16 mm in diameter was added to 2 mL of artificial perspiration and incubated at 37° C. for 3 hours. At 3 hours, the artificial perspiration was collected and filtered through a 0.22 μm syringe filter, then 500 μL was added to a confluent well of primary human dermal fibroblasts, plated in a 24-well plate. The primary human dermal fibroblasts with artificial perspiration were incubated in a humidified atmosphere at 37° C. and 5% CO₂ for 3 hours. At 3 hours, the artificial perspiration was removed, and cells were stained with a Live/Dead solution of 1 μM Calcein AM and 4 μM Ethidium homodimer-1. The dead positive control was prepared by incubating cells with ice-cold 70% ethanol for 15 minutes prior to staining. Each well was stained and protected from light at room temperature for 30 minutes with 500 μL of textile-treated perspiration. After 30 minutes, the staining solution was removed, and cells were stored in 500 μL PBS during imaging. The results demonstrated that the Cu-IT does not cause cytotoxicity due to ions produced from the Cu-IT's contact with human perspiration. In summary, the observed antiviral and bacteriostatic properties suggest that Cu-IT has high application potential in personal, clinical and medical environments.

The mechanical properties and washing stability of the Cu-IT was also assessed. The textile could be folded, crumpled, and unfolded without issue, showing general characteristics comparable to unmodified textiles, which can be attributed to the well-preserved structures of the cellulose microfibers and macroscopic material integrity during treatment by the Cu(II)-saturated NaOH solution. To test the material's washing stability in water with detergent, a piece of Cu-IT was washed and dried. In particular, the washing and drying procedures used to test the Cu-IT were based on an international standard (ISO 6330-2012, entitled “Domestic washing and drying procedures for textile testing,” published April 2012, which is incorporated by reference herein). A front-loading, horizontal drum type washing machine (FOM71 CLS) was used. A piece of Cu-IT sample (5 cm×5 cm) was loaded into the washing machine with sufficient ballast test pieces (100% knitted polyester texturized filament fabric) and 20 g of non-phosphate detergent (ECE reference detergent 98). The washing procedure of 4M was applied, in which the wash time was 15 minutes and the wash temperature was 40° C. Three rinse steps were applied after washing and the rinse times were 3 minutes, 2 minutes, and 2 minutes. After rinsing, the Cu-IT sample was removed from the machine and, without extracting the water, suspended from a line in still air at room temperature and allowed to dry. For the modified washing tests, the Cu-IT samples were extensively washed in a vigorously stirred (1000 rpm) water bath with detergent added. In an example, a piece of Cu-IT with a size of 9 cm×4.5 cm was immersed into ~200 mL of water with 1 g of detergent. The washing and drying of the Cu-IT yielded no apparent changes of color or decreased integrity.

As verified by the XAS of FIGS. 8A-8B and the XRD of FIG. 8C, the coordinated structures in the Cu-IT were maintained after washing and drying. Moreover, the Cu K-edge XANES and EXAFS spectra of the Cu-IT before and after washing were almost identical (e.g., the lines are essentially superimposed), and the XRD profiles show nearly the same diffraction patterns. Furthermore, the Cu concentration was measured in the wash wastewater from a modified (non-ISO) wash test. Using a relationship between leached copper over time, it was estimated that the Cu-IT should endure thousands of washing cycles before reaching its Cu half-life time (when the Cu content in the Cu-IT decreases to half of its original value). This is longer than the typical lifespan of 200 wash-use cycles for cotton fabric. The antiviral and antibacterial performance of the Cu-IT samples was also re-assessed after washing. As shown in FIGS. 8D-8E, the antiviral and antibacterial activities generally did not decay after repeated washing, suggesting Cu-IT reusability.

After being stored for over a year under ambient conditions, no structural change was observed in the XRD profiles of the Cu-IT. Additionally, the stability of Cu-IT against UV, heat, and sweat was confirmed. In particular, the Cu-IT samples were placed under a UV lamp (emission wavelength: 405 nm, output power: 60 W) for different times, and separately placed in an oven at 75° C. for different times. Separately, the Cu-IT samples were soaked for different times in artificial human sweat, which was prepared based on international standard (ISO 105-E04:1989(E), entitled “Textiles—Tests for colour fastness. Part E04: Colour fastness to perspiration,” published December 1989, which is incorporated by reference herein). For example, 0.5 g of l-histidine monohydrochloride monohydrate, 5 g of sodium chloride (NaCl), and 2.5 g of disodium hydrogen orthophosphate dihydrate (Na₂HPO₄·2H₂O) were dissolved in 1 L of water and then brought to pH 8 with 0.1 mol/L sodium hydroxide solution.

To investigate the durability of Cu-IT against abrasion during normal wear use, abrasion resistance tests were performed on the Cu-IT and unmodified textile, according to international standard (ISO 12947-2:2016, entitled “Textiles—Determination of the abrasion resistance of fabrics by the Martindale method. Part 2: Determination of specimen breakdown,” published December 2016, which is incorporated by reference herein). In particular, textile samples with a diameter of 38 mm and wool abradant fabrics with a diameter of 120 mm were mounted to a Martindale machine. The effective mass of the abrasion load was 2.5 kg. The textile samples were abraded for 10000 rubs with an inspection interval after every 2000 rubs. After the abrasion tests, no apparent decrease of integrity was observed in the Cu-IT, while a rupture of the fibers occurred for the unmodified textile. Additionally, the Cu-IT maintained its Cu content after abrasion, indicative of the even distribution of Cu ions throughout the fibers, which should ensure excellent antiviral and antibacterial performance during everyday use.

Uniaxial tensile tests of the Cu-IT and unmodified textile were performed to quantify the mechanical performance. As shown in FIG. 8F, the tensile strength of Cu-IT was 26.79 MPa, which is ~23% higher than that of the unmodified textile (21.75 MPa). In addition, cotton textile treated solely with aqueous NaOH solution (a process also known as mercerization) showed the lowest strength of 20.35 MPa, which may be attributed to the decrease of the degree of polymerization of the cellulose polymers caused by the concentrated NaOH exposure. The Cu-IT also exhibited different fracture properties compared with the unmodified textile. For example, the fracture area of the Cu-IT was compact with a granular-type fracture, while that of the unmodified textile was loose with a fibrillary-type fracture. This demonstrates that the Cu-coordination within the cellulose fibers improves the mechanical properties of the Cu-IT and highlights the role of Cu ions in stabilizing the secondary structure of cellulose.

In another fabricated example, a Cu-IT T-shirt was produced from a commercially available cotton T-shirt. The original cotton T-shirt was placed in a 300 mm×200 mm×30 mm container filled with Cu(II)-saturated NaOH solution and soaked for ~7 days until the color turned blue. The Cu-IT T-shirt was produced after washing and drying, with well-preserved physical properties but slight shrinkage, which may be due to the alkaline solution treatment and the Cu ion coordination. In another fabricated example, a roll of Cu-IT cloth of 35 cm in width and 280 cm in length was prepared from unbleached cotton cloth using the same method. Notably, the inherent color of Cu-IT is similar to personal protective equipment (PPE) that is commonly used in health care settings, and thus can avoid a subsequent dying step for use in such settings. Altogether, this highly scalable, low-cost, and eco-friendly fabrication process endows Cu-IT with great potential for practical use.

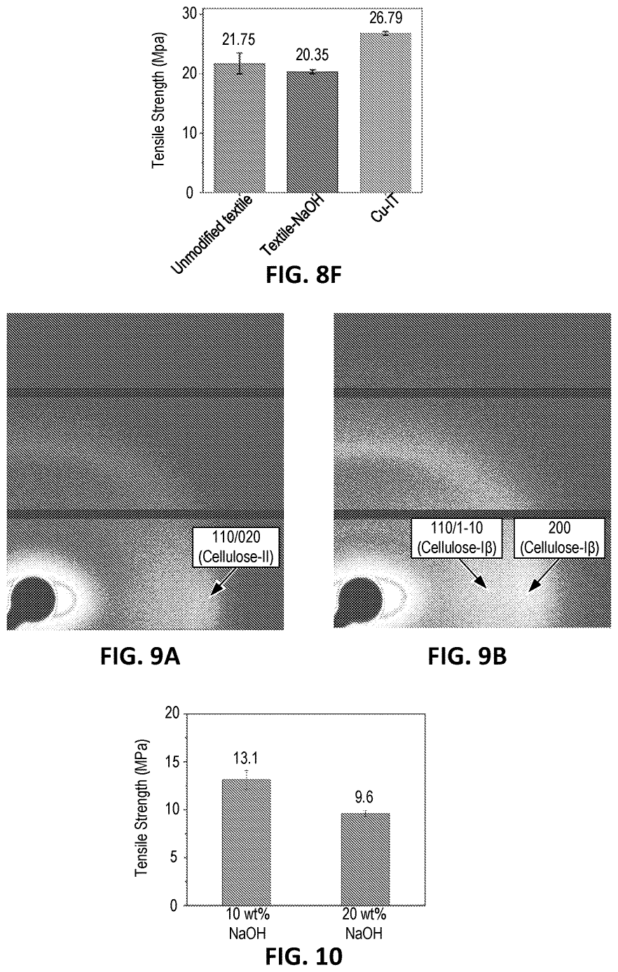

As noted above, higher concentrations of alkaline solution may overly swell the cellulose matrix and be too viscous to allow for adequate metal ion coordination. Moreover, the higher concentrations of alkaline solution can also prevent the dried cellulose matrix from recovering the original cellulose-I lattice structure. For example, natural pieces of wood (without any prior delignification) were soaked in Cu(II)-saturated aqueous NaOH solutions for three days, one solution having a concentration of 20 wt % NaOH and the other having a concentration of 10 wt % NaOH. Ater soaking the Cu-ion wood pieces were washed with water and then dried. The crystal structures of the dried wood pieces were evaluated using wide-angle X-ray diffraction (WAXD), the results of which are shown in FIGS. 9A-9B. As shown in FIG. 9A, the Cu-ion wood prepared with 20 wt % NaOH exhibited a cellulose-II lattice structure (e.g., reflections 110/020 dominate). In contrast, the Cu-ion wood prepared with 10 wt % NaOH exhibited a cellulose-I lattice structure, in particular, cellulose-Iβ, as shown in FIG. 9B.

Such higher concentrations of alkaline solution, and the resulting cellulose-II lattice retained after drying, may also negatively affect the mechanical strength of the final structure. For example, pieces of pure cellulose filter paper (e.g., having randomly oriented cellulose fibers, to provide substantially isotropic properties) were soaked in separate Cu(II)-saturated aqueous NaOH solutions for three days, one solution having a concentration of 20 wt % NaOH (e.g., 3.5 N NaOH) and the other having a concentration of 10 wt % NaOH. After soaking, the Cu-ion papers were washed with water and then dried. Uniaxial tensile tests were performed on each Cu-ion paper to assess the tensile strength thereof. As shown in FIG. 10, the Cu-ion paper prepared with 10 wt % NaOH exhibited a tensile strength of 13.1 MPa, which was significantly higher (e.g., 36% more) than the tensile strength of the Cu-ion paper prepared with 20 wt % NaOH (e.g., 9.6 MPa).

### ADDITIONAL EXAMPLES OF THE DISCLOSED TECHNOLOGY

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.

Clause 1. A structure comprising:
an antimicrobial material comprising:
   one or more fibers, each fiber comprising a plurality of cellulose molecular chains with functional groups; and
   a plurality of metal ions impregnated within the one or more fibers, such that each metal ion forms a coordination bond between functional groups of adjacent cellulose molecular chains,
wherein the one or more fibers exhibit a cellulose-I lattice structure.

Clause 2. The structure of any clause or example herein, in particular, Clause 1, wherein the plurality of metal ions comprises copper (Cu), zinc (Zn), gold (Au), silver (Ag), titanium (Ti), or any combination of the foregoing.

Clause 3. The structure of any clause or example herein, in particular, any one of Clauses 1-2, wherein the plurality of metal ions comprises Cu(II).

Clause 4. The structure of any clause or example herein, in particular, any one of Clauses 1-3, wherein the functional groups comprise oxygen-containing functional groups.

Clause 5. The structure of any clause or example herein, in particular, Clause 4, wherein the oxygen-containing functional groups are hydroxyl groups.

Clause 6. The structure of any clause or example herein, in particular, any one of Clauses 1-5, wherein a total water content of the antimicrobial material is less than or equal to 10 wt %.

Clause 7. The structure of any clause or example herein, in particular, any one of Clauses 1-6, further comprising a substrate, wherein the antimicrobial material is coated on or attached to a surface of the substrate.

Clause 8. The structure of any clause or example herein, in particular, Clause 7, wherein the substrate comprises a structural member or layer.

Clause 9. The structure of any clause or example herein, in particular, Clause 8, wherein the structural member or layer comprises metal, wood, bamboo, plastic, or any combination of the foregoing.

Clause 10. The structure of any clause or example herein, in particular, any one of Clauses 1-9, wherein the antimicrobial material is a surface layer of a contiguous member, and an interior portion of the contiguous member away from the surface layer comprises one or more cellulose-based fibers lacking the plurality of metal ions.

Clause 11. The structure of any clause or example herein, in particular, any one of Clauses 1-10, wherein the one or more fibers are from a fibrous plant material.

Clause 12. The structure of any clause or example herein, in particular, Clause 11, wherein the fibrous plant material is or comprises cotton.

Clause 13. The structure of any clause or example herein, in particular, Clause 11, wherein the fibrous plant material is or comprises wood or bamboo.

Clause 14. The structure of any clause or example herein, in particular, Clause 13, wherein the wood or bamboo is at least partially delignified.

Clause 15. The structure of any clause or example herein, in particular, any one of Clauses 1-14, wherein the antimicrobial material has been compressed so as to have a density greater than or equal to 1 g/cm³.

Clause 16. The structure of any clause or example herein, in particular, any one of Clauses 1-15, wherein a content of the plurality of metal ions in the antimicrobial material is at least 8 wt %.

Clause 17. The structure of any clause or example herein, in particular, any one of Clauses 1-16, wherein a content of the plurality of metal ions in the antimicrobial material is in a range of about 8 wt % to about 13 wt %.

Clause 18. The structure of any clause or example herein, in particular, any one of Clauses 1-17, wherein the one or more fibers is a plurality of fibers forming a textile, sheet, film, block, or membrane.

Clause 19. The structure of any clause or example herein, in particular, any one of Clauses 1-18, wherein the antimicrobial material acts as an antiviral agent, an antibacterial agent, an antifungal agent, an antiprotozoal agent, or any combination of the foregoing.

Clause 20. The structure of any clause or example herein, in particular, any one of Clauses 1-19, wherein the antimicrobial material exhibits an improved mechanical strength as compared to the one or more fibers without the plurality of metal ions.

Clause 21. The structure of any clause or example herein, in particular, any one of Clauses 1-20, wherein the antimicrobial material exhibits a tensile strength of at least 24 MPa.

Clause 22. A method comprising:
exposing one or more microbes to an antimicrobial material of a structure so as to kill the one or more microbes and/or inhibit replication of the one or more microbes,
wherein the antimicrobial material comprises:
   one or more fibers, each fiber comprising a plurality of cellulose molecular chains with functional groups; and
   a plurality of metal ions impregnated within the one or more fibers, such that each metal ion forms a coordination bond between functional groups of adjacent cellulose molecular chains, and
the one or more fibers exhibit a cellulose-I lattice structure.

Clause 23. The method of any clause or example herein, in particular, Clause 22, wherein: the one or more microbes comprise a virus and the antimicrobial material acts as an antiviral agent;
the one or more microbes comprise a bacteria and the antimicrobial material acts as an antibacterial agent;
the one or more microbes comprise a fungus and the antimicrobial material acts as an antifungal agent;
the one or more microbes comprise a protozoa and the antimicrobial material acts as an antiprotozoal agent; or
any combination of the above.

Clause 24. The method of any clause or example herein, in particular, any one of Clauses 22-23, wherein the plurality of metal ions comprises copper (Cu), zinc (Zn), gold (Au), silver (Ag), titanium (Ti), or any combination of the foregoing.

Clause 25. The method of any clause or example herein, in particular, any one of Clauses 22-24, wherein the plurality of metal ions comprises Cu(II).

Clause 26. The method of any clause or example herein, in particular, any one of Clauses 22-25, wherein the functional groups comprise oxygen-containing functional groups.

Clause 27. The method of any clause or example herein, in particular, Clause 26, wherein the oxygen-containing functional groups are hydroxyl groups.

Clause 28. The method of any clause or example herein, in particular, any one of Clauses 22-27, wherein a content of the plurality of metal ions in the antimicrobial material is at least 8 wt %.

Clause 29. The method of any clause or example herein, in particular, any one of Clauses 22-28, wherein a content of the plurality of metal ions in the antimicrobial material is in a range of about 8 wt % to about 13 wt %.

Clause 30. The method of any clause or example herein, in particular, any one of Clauses 22-29, wherein the one or more fibers is a plurality of fibers forming a textile, sheet, film, block, or membrane.

Clause 31. The method of any clause or example herein, in particular, any one of Clauses 22-30, further comprising, prior to the exposing, providing the structure.

Clause 32. The method of any clause or example herein, in particular, Clause 31, wherein the providing comprises:
immersing the one or more fibers in an alkaline solution having the plurality of metal ions dissolved therein, the immersing being such that hydrogen bonds between the functional groups of adjacent cellulose molecular chains are broken so as to expose the functional groups and such that the dissolved metal ions form the coordination bonds with the exposed functional groups;
after the immersing, rinsing the one or more fibers with the metal ions impregnated therein; and
after the rinsing, drying the one or more fibers so as to form the antimicrobial material.

Clause 33. A method comprising:
immersing one or more fibers in an alkaline solution having a plurality of metal ions dissolved therein, each fiber comprising a plurality of cellulose molecular chains with functional groups, the immersing being such that hydrogen bonds between the functional groups of adjacent cellulose molecular chains are broken so as to expose the functional groups and such that the dissolved metal ions are impregnated within the one or more fibers and form coordination bonds with the exposed functional groups;
after the immersing, rinsing the one or more fibers with the metal ions impregnated therein; and
after the rinsing, drying the one or more fibers so as to form an antimicrobial material, the one or more fibers within the antimicrobial material exhibiting a cellulose-I lattice structure.

Clause 34. The method of any clause or example herein, in particular, any one of Clauses 32-33, wherein:
after the immersing and prior to the drying, the one or more fibers exhibit a cellulose-II metal-ion lattice structure; and
after the drying, the one or more fibers exhibit the cellulose-I lattice structure.

Clause 35. The method of any clause or example herein, in particular, any one of Clauses 32-34, wherein, after the drying, a total water content of the antimicrobial material is less than or equal to 10 wt %.

Clause 36. The method of any clause or example herein, in particular, any one of Clauses 32-35, wherein the alkaline solution comprises sodium hydroxide (NaOH), potassium hydroxide (KOH), lithium hydroxide (LiOH), or any combination of the foregoing.

Clause 37. The method of any clause or example herein, in particular, any one of Clauses 32-36, wherein a concentration of the alkaline solution is less than or equal to 15 wt %.

Clause 38. The method of any clause or example herein, in particular, any one of Clauses 32-37, wherein a concentration of the alkaline solution is in a range from about 5 wt % to about 10 wt %.

Clause 39. The method of any clause or example herein, in particular, any one of Clauses 32-38, wherein, during the immersing, the one or more fibers are part of a contiguous piece of fibrous plant material.

Clause 40. The method of any clause or example herein, in particular, any one of Clauses 32-39, wherein the fibrous plant material is or comprises cotton.

Clause 41. The method of any clause or example herein, in particular, any one of Clauses 32-39, wherein the fibrous plant material is or comprises wood and/or bamboo.

Clause 42. The method of any clause or example herein, in particular, Clause 41, further comprising, prior to the immersing, subjecting the contiguous piece of wood or bamboo to one or more chemical treatments so as to remove at least some of native lignin from the contiguous piece.

Clause 43. The method of any clause or example herein, in particular, Clause 41, further comprising, prior to the immersing, subjecting the contiguous piece of wood or bamboo to a chemical treatment so as to modify native lignin within the contiguous piece.

Clause 44. The method of any clause or example herein, in particular, any one of Clauses 39-43, further comprising, after the rinsing, pressing the contiguous piece so as to collapse lumina formed by a native cellulose-based microstructure of the fibrous plant material, thereby forming a densified piece of the fibrous plant material.

Clause 45. The method of any clause or example herein, in particular, Clause 44, wherein the pressing includes and/or is performed at a same time as the drying.

Clause 46. The method of any clause or example herein, in particular, any one of Clauses 44-45, wherein:
prior to the pressing, the contiguous piece of fibrous plant material has a density less than 1 g/cm³; and
after the pressing, the densified piece of fibrous plant material has a density of at least 1 g/cm³.

Clause 47. The method of any clause or example herein, in particular, any one of Clauses 39-46, wherein the immersing is such that, after the drying, the antimicrobial material is formed as a surface layer of the contiguous piece of fibrous plant material, and an interior portion of the contiguous piece away from the surface layer comprises one or more cellulose-based fibers lacking the plurality of metal ions.

Clause 48. The method of any clause or example herein, in particular, any one of Clauses 32-47, wherein a mechanical strength of the one or more fibers after the drying is greater than a mechanical strength of the one or more fibers prior to the immersing.

Clause 49. The method of any clause or example herein, in particular, any one of Clauses 31-48, wherein the providing comprises, or the method further comprises, disposing the antimicrobial material on a surface of a substrate so as to form the structure.

Clause 50. The method of any clause or example herein, in particular, any one of Clauses 31-49, wherein the providing comprises, or the method further comprises:
prior to the immersing, subjecting a parent structure containing the one or more fibers to a mechanical fibrillation process, a chemical fibrillation process, an enzymatic fibrillation process, or any combination thereof, so as to expose the one or more fibers from the parent structure.

Clause 51. The method of any clause or example herein, in particular, Clause 50, wherein the parent structure comprises one or more pieces of a fibrous plant material, such as wood or bamboo.

Clause 52. The method of any clause or example herein, in particular, any one of Clauses 31-51, wherein the providing comprises or the method further comprises, after the rinsing, coating the one or more fibers with metal ions impregnated therein on a surface of a substrate so as to form the structure.

Clause 53. The method of any clause or example herein, in particular, any one of Clauses 49-52, wherein the substrate comprises a structural member or layer.

Clause 54. The method of any clause or example herein, in particular, Clause 53, wherein the structural member or layer comprises metal, wood, bamboo, plastic, or any combination of the foregoing.

Clause 55. The structure formed by the method of any clause or example herein, in particular, any one of Clauses 31-54.

### CONCLUSION

Any of the features illustrated or described herein, for example, with respect to FIGS. 1-10 and Clauses 1-55, can be combined with any other feature illustrated or described herein, for example, with respect to FIGS. 1-10 and Clauses 1-55 to provide systems, devices, materials, structures, methods, and embodiments not otherwise illustrated or specifically described herein. All features described herein are independent of one another and, except where structurally impossible, can be used alone or in combination with any other feature described herein. In view of the many possible embodiments to which the principles of the disclosed technology may be applied, it should be recognized that the illustrated embodiments are only examples and should not be taken as limiting the scope of the disclosed technology. Rather, the scope is defined by the following claims. We therefore claim all that comes within the scope and spirit of these claims.

1. A structure comprising:
an antimicrobial material comprising:
one or more fibers, each fiber comprising a plurality of cellulose molecular chains with functional groups; and
a plurality of metal ions impregnated within the one or more fibers, such that each metal ion forms a coordination bond between functional groups of adjacent cellulose molecular chains,
wherein the one or more fibers exhibit a cellulose-I lattice structure.

2. The structure of claim 1, wherein the plurality of metal ions comprises copper (Cu), zinc (Zn), gold (Au), silver (Ag), titanium (Ti), or any combination of the foregoing.

3. (canceled)

4. The structure of claim 1, wherein the functional groups comprise oxygen-containing functional groups.

5-6. (canceled)

7. The structure of claim 1, further comprising:
a substrate,
wherein the antimicrobial material is coated on or attached to a surface of the substrate.

8-9. (canceled)

10. The structure of claim 1, wherein the antimicrobial material is a surface layer of a contiguous member, and an interior portion of the contiguous member away from the surface layer comprises one or more cellulose-based fibers lacking the plurality of metal ions.

11-12. (canceled)

13. The structure of claim 1, wherein the one or more fibers are from wood or bamboo, and the wood or bamboo is at least partially delignified.

14-15. (canceled)

16. The structure of claim 1, wherein a content of the plurality of metal ions in the antimicrobial material is at least 8 wt %.

17-19. (canceled)

20. The structure of claim 1, wherein the antimicrobial material exhibits an improved mechanical strength as compared to the one or more fibers without the plurality of metal ions.

21. (canceled)

22. A method comprising:
exposing one or more microbes to an antimicrobial material of a structure so as to kill the one or more microbes and/or inhibit replication of the one or more microbes,
wherein the antimicrobial material comprises:
one or more fibers, each fiber comprising a plurality of cellulose molecular chains with functional groups; and
a plurality of metal ions impregnated within the one or more fibers, such that each metal ion forms a coordination bond between functional groups of adjacent cellulose molecular chains, and
the one or more fibers exhibit a cellulose-I lattice structure.

23. (canceled)

24. The method of claim 22, wherein:
the plurality of metal ions comprises copper (Cu), zinc (Zn), gold (Au), silver (Ag), titanium (Ti), or any combination of the foregoing; and
the functional groups comprise oxygen-containing functional groups.

25-31. (canceled)

32. A method comprising:
immersing one or more fibers in an alkaline solution having a plurality of metal ions dissolved therein, each fiber comprising a plurality of cellulose molecular chains with functional groups, the immersing being such that hydrogen bonds between the functional groups of adjacent cellulose molecular chains are broken so as to expose the functional groups and such that the dissolved metal ions form coordination bonds with the exposed functional groups;
after the immersing, rinsing the one or more fibers with the metal ions impregnated therein; and
after the rinsing, drying the one or more fibers so as to form an antimicrobial material,
wherein the plurality of metal ions are impregnated within the one or more fibers of the antimicrobial material, and
the one or more fibers of the antimicrobial material exhibit a cellulose-I lattice structure.

33. The method of claim 32, wherein:
after the immersing and prior to the drying, the one or more fibers exhibit a cellulose-II metal-ion lattice structure; and
after the drying, the one or more fibers exhibit the cellulose-I lattice structure.

34. (canceled)

35. The method of claim 32, wherein the alkaline solution comprises sodium hydroxide (NaOH), potassium hydroxide (KOH), lithium hydroxide (LiOH), or any combination of the foregoing.

36. The method of claim 32, wherein a concentration of the alkaline solution is less than or equal to 15 wt %.

37. (canceled)

38. The method of claim 32, wherein, during the immersing, the one or more fibers are part of a contiguous piece of fibrous plant material.

39. (canceled)

40. The method of claim 38, wherein the fibrous plant material is wood or bamboo.

41. The method of claim 40, further comprising, prior to the immersing:
subjecting the contiguous piece of wood or bamboo to one or more chemical treatments so as to remove at least some of native lignin from the contiguous piece; or
subjecting the contiguous piece of wood or bamboo to a chemical treatment so as to modify native lignin within the contiguous piece.

42. (canceled)

43. The method of claim 40, further comprising:
after the rinsing, pressing the contiguous piece of wood or bamboo so as to collapse lumina formed by a native cellulose-based microstructure of the wood or bamboo, thereby forming a densified piece of wood or bamboo.

44. The method of claim 43, wherein the pressing is performed at a same time as the drying.

45. (canceled)

46. The method of claim 38, wherein the immersing is such that, after the drying, the antimicrobial material is formed as a surface layer of the contiguous piece of fibrous plant material, and an interior portion of the contiguous piece away from the surface layer comprises one or more cellulose-based fibers lacking the plurality of metal ions.

47-54. (canceled)
